(19) United States
(12) Patent Application Publication
(10) Pub. No.: US 2025/0151138 A1
(43) Pub. Date: May 8, 2025

(54) METHOD AND APPARATUS FOR PATH SELECTION

(71) Applicant: Telefonaktiebolaget LM Ericsson (publ), Stockholm (SE)

(72) Inventors: Zhang ZHANG, Beijing (CN); Nithin SRINIVASAN, Köln (DE)

(73) Assignee: Telefonaktiebolaget LM Ericsson (publ), Stockholm (SE)

(21) Appl. No.: 18/867,894

(22) PCT Filed: May 24, 2023
(86) PCT No.: PCT/CN2023/096048

§ 371 Date: Nov. 21, 2024

(30) Foreign Application Priority Data
May 25, 2022 (WO) PCT/CN2022/095052

(51) Int. Cl. H04W 76/14; H04W 88/04

(52) U.S. Cl. CPC H04W 76/14; H04W 88/04

(57) ABSTRACT

Embodiments of the present disclosure provide method and apparatus for path selection. A method performed by a first network node may comprise determining at least one candidate relay user equipment (UE) served by a second network node. The method may further comprise sending a first message comprising first information of the at least one candidate relay UE to the second network node. The method further comprises receiving a second message from the second network node. The second message may comprise at least one path for the UE to access the second network node. The method may further comprise sending the at least one path to a UE served by the first network node to enable the UE to setup the at least one path. The at least one candidate relay UE is able to be used for establishing at least one indirect path between the UE and the second network node.

### TECHNICAL FIELD

The non-limiting and exemplary embodiments of the present disclosure generally relate to the technical field of communications, and specifically to methods and apparatuses for path selection.

### BACKGROUND

This section introduces aspects that may facilitate a better understanding of the disclosure. Accordingly, the statements of this section are to be read in this light and are not to be understood as admissions about what is in the prior art or what is not in the prior art.

In communication networks for example new radio (NR) as defined by 3rd Generation Partnership Project (3GPP), a handover (HO)/path switch procedure may be used to hand over a terminal device such as user equipment (UE) from a source network node to a target network node.

Clause 4.9 of 3GPP TS 23.502 V17.1.1, the disclosure of which is incorporated by reference herein in its entirety, describes various handover procedures, such as handover procedures in 3GPP access, etc. These handover procedures may be used to hand over a UE from a source NG-RAN (next generation (NG) radio access network (RAN)) node to a target NG-RAN node using the Xn or N2 reference points. A handover procedure can be triggered, for example, due to new radio conditions, load balancing or due to specific service e.g. in the presence of quality of service (QoS) flow for voice, the source NG-RAN node being NR may trigger handover to E-UTRA ((Evolved Universal Terrestrial Radio Access) connected to 5GC (fifth generation core).

3GPP TS 23.401 V17.3.0, the disclosure of which is incorporated by reference herein in its entirety, describes various handover procedures, such as Intra-E-UTRAN handover, etc. These handover procedures may be used to hand over a UE from a source eNodeB (evolved Node B) to a target eNodeB using the X2 reference point. In these handover procedures the MME (Mobile Management Entity) is unchanged.

Enhancements to sidelink (SL) relay will be further investigated in 3GPP Release. 18 (e.g., RP-213585, New WID on NR Sidelink Relay Enhancements, TSG RAN #94-e), one of the objectives of the work item is to specify mechanisms to enhance service continuity for single-hop layer 2 (L2) UE-to-Network relay, the considered scenarios include inter-gNB indirect-to-direct path switching, inter-gNB direct-to-indirect path switching, intra-gNB indirect-to-indirect path switching and inter-gNB indirect-to-indirect path switching.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There may be some issues in the current handover/path switch mechanism.

For example, for intra radio access network (RAN) path switching to an indirect path, a target relay UE is selected by the RAN serving a remote UE which also serves the target relay UE. For inter-RAN path switching to an indirect path, one straightforward way is also let a source RAN serving the remote UE select the target relay UE served by another RAN. However, the source RAN does not know some information of relay UEs served by different RANs and/or some information of target RAN, e.g., the Uu hop performance of relay UEs served by different RANs, radio resource control (RRC) connected state of the candidate relay UE, Uu discontinuous reception (DRX) configuration of the candidate relay UE, whether the target RAN supports multipath communication involving relay UE, etc., which may lead to that the selected target relay UE is sub-optimal or not admitted by the RAN serving the relay UE. In some cases, the path switching latency will increase (as the source RAN has to try another relay UE or RAN) or even the path switching may be failed,

Besides, currently selection between direct path and indirect path is also determined by the source RAN serving the remote UE. Similarly this may lead to sub-optimal performance as the source RAN does not have full knowledge of indirect path's performance.

To overcome or mitigate at least one of above mentioned problems or other problems, the embodiments of the present disclosure propose an improved solution for path selection.

In a first aspect of the disclosure, there is provided a method performed by a first network node. The method may comprise determining at least one candidate relay user equipment (UE) served by a second network node. The method may further comprise sending a first message comprising first information of the at least one candidate relay UE to the second network node. The method may further comprise receiving a second message from the second network node. The second message may comprise at least one path for the UE to access the second network node. The method may further comprise sending the at least one path to a UE served by the first network node to enable the UE to setup the at least one path. The at least one candidate relay UE is able to be used for establishing at least one indirect path between the UE and the second network node.

In an embodiment, a handover/path switch procedure used to hand over the UE from the first network node to the second network node is to be performed.

In an embodiment, the first information may comprise at least one of respective identifier of the at least one candidate relay UE, or respective sidelink performance of the at least one candidate relay UE.

In an embodiment, the first information may comprise at least one of respective identifier of the at least one candidate relay UE, respective sidelink performance of the at least one candidate relay UE, an indication that a direct path and at least one indirect path are suitable for the UE to access the second network node, Uu performance of a direct path between the UE and the second network node, a preference of direct path or indirect path, information regarding whether the UE supports multipath communication involving relay UE, or information regarding whether the UE demands to use multipath communication involving relay UE.

In an embodiment, the at least one path may comprise at least one of at least one indirect path between the UE and the second network node, or a direct path between the UE and the second network node.

In an embodiment, the method may further comprise coordinating with the second network node to decide at least one of the first network node is responsible for selecting the at least one path for the UE to access the second network node, the second network node is responsible for selecting the at least one path for the UE to access the second network node, or the first network node is responsible for selecting at least one indirect path and the second network node is responsible for selecting a direct path and/or the at least one indirect path.

In a second aspect of the disclosure, there is provided a method performed by a second network node. The method may comprise receiving a first message comprising first information of at least one candidate relay UE served by the second network node from a first network node. The method may further comprise selecting at least one path for a UE served by the first network node to access the second network node based on the first information and assistance information regarding the at least one candidate relay UE. The method may further comprise sending a second message to the first network node. The second message may comprise the at least one path for the UE to access the second network node. The at least one candidate relay UE is able to be used for establishing at least one indirect path between the UE and the second network node.

In an embodiment, a handover/path switch procedure used to hand over the UE from the first network node to the second network node is to be performed.

In an embodiment, the first information may comprise at least one of respective identifier of the at least one candidate relay UE, or respective sidelink performance of the at least one candidate relay UE.

In an embodiment, the first information may comprise at least one of respective identifier of the at least one candidate relay UE, respective sidelink performance of the at least one candidate relay UE, an indication that a direct path and at least one indirect path are suitable for the UE to access the second network node, Uu performance of a direct path between the UE and the second network node, a preference of direct path or indirect path, information regarding whether the UE supports multipath communication involving relay UE, or information regarding whether the UE demands to use multipath communication involving relay UE.

In an embodiment, the assistance information regarding the at least one candidate relay UE may comprise at least one of respective Uu performance of the at least one candidate relay UE, respective quality of service (QOS) supported by the at least one candidate relay UE, a best QoS supported by the at least one candidate relay UE, respective Uu discontinuous reception (DRX) configuration of the at least one candidate relay UE, respective sidelink performance of the at least one candidate relay UE, respective radio resource control (RRC) connected state of the at least one candidate relay UE, or information regarding whether the network node supports multipath communication involving relay UE.

In an embodiment, selecting at least one path for a UE served by the first network node to access the second network node based on the first information may comprise: when the first information comprises a preference of direct path or indirect path, checking whether a preferred path can be selected; when the preferred path can be selected, selecting the preferred path; and stopping checking other path.

In an embodiment, the at least one path may comprise at least one of at least one indirect path between the UE and the second network node, or a direct path between the UE and the second network node.

In an embodiment, the method further coordinating with the first network node to decide at least one of the first network node is responsible for selecting the at least one path for the UE to access the second network node, the second network node is responsible for selecting the at least one path for the UE to access the second network node, or the first network node is responsible for selecting at least one indirect path and the second network node is responsible for selecting a direct path and/or the at least one indirect path.

In a third aspect of the disclosure, there is provided a method performed by a first network node. The method may comprise receiving first assistance information regarding one or more candidate relay UEs served by a second network node from the second network node. The method may further comprise determining at least one candidate relay UE served by the second network node. The method may further comprise selecting at least one path for a UE served by the first network node to access the second network node based on at least one of the first assistance information, first information of the at least one candidate relay UE, or respective radio resource control (RRC) connected state of the at least one candidate relay UE. The at least one candidate relay UE is able to be used for establishing at least one indirect path between the UE and the second network node.

In an embodiment, a handover/path switch procedure used to hand over the UE from the first network node to the second network node is to be performed.

In an embodiment, the first information may comprise at least one of respective identifier of the at least one candidate relay UE, or respective sidelink performance of the at least one candidate relay UE.

In an embodiment, the first information may comprise at least one of respective identifier of the at least one candidate relay UE, respective sidelink performance of the at least one candidate relay UE, an indication that a direct path and at least one indirect path are suitable for the UE to access the second network node, Uu performance of a direct path between the UE and the second network node, a preference of direct path or indirect path, information regarding whether the UE supports multipath communication involving relay UE, or information regarding whether the UE demands to use multipath communication involving relay UE.

In an embodiment, the method further receiving respective second assistance information from at least one third network node. The method may further comprise determining the second network node based on the respective second assistance information and the first assistance information. Second assistance information from a third network node may comprise assistance information regarding one or more candidate relay UEs served by the third network node.

In an embodiment, assistance information regarding one or more candidate relay UEs served by a network node may comprise at least one of respective identifier of one or more candidate relay UEs served by the network node, respective Uu performance of one or more candidate relay UEs served by the network node, respective quality of service (QOS) supported by one or more candidate relay UEs served by the network node, a best QoS supported by one or more candidate relay UEs served by the network node, respective Uu discontinuous reception (DRX) configuration of one or more candidate relay UEs served by the network node, respective sidelink performance of one or more candidate relay UEs served by the network node, or information regarding whether the network node supports multipath communication involving relay UE.

In an embodiment, assistance information regarding one or more candidate relay UEs served by a network node is received by the first network node proactively and/or in response to a request sent to the network node.

In an embodiment, the respective RRC connected state of at least one candidate relay UE served by the second network node is comprised in the first assistance information or inferred by the first network node based on the first assistance information.

In an embodiment, when the first network node is responsible for selecting at least one indirect path for the UE served by the first network node to access the second network node, the method may further comprise sending a third message to the second network node. The method may further comprise receiving a fourth message from the second network node. The fourth message may comprise at least one path for the UE to access the second network node The third message may comprise at least one of respective identifier of at least one target relay UE of the at least one indirect path, an indication that a direct path and at least one indirect path are suitable for the UE to access the second network node, Uu performance of a direct path between the UE and the second network node, respective sidelink performance of at least one target relay UE of the at least one indirect path, a preference of direct path or indirect path, information regarding whether the UE supports multipath communication involving relay UE, or information regarding whether the UE demands to use multipath communication involving relay UE.

In an embodiment, the at least one path may comprise at least one of at least one indirect path between the UE and the second network node, or a direct path between the UE and the second network node.

In an embodiment, the method further coordinating with the second network node to decide at least one of the first network node is responsible for selecting the at least one path for the UE to access the second network node, the second network node is responsible for selecting the at least one path for the UE to access the second network node, or the first network node is responsible for selecting at least one indirect path and the second network node is responsible for selecting a direct path and/or the at least one indirect path.

In an embodiment, the method further sending the at least one path to the UE to enable the UE to setup the at least one path.

In an embodiment, the method further sending the at least one path to the second network node.

In a fourth aspect of the disclosure, there is provided a method performed by a second network node. The method may comprise sending first assistance information regarding one or more candidate relay UEs served by the second network node to a first network node. The first assistance information is used for selecting at least one path for a UE served by the first network node to access the second network node.

In an embodiment, a handover/path switch procedure used to hand over the UE from the first network node to the second network node is to be performed.

In an embodiment, the first assistance information may comprise at least one of respective identifier of one or more candidate relay UEs served by the second network node, respective Uu performance of one or more candidate relay UEs served by the second network node, respective quality of service (QOS) supported by one or more candidate relay UEs served by the second network node, a best QoS supported by one or more candidate relay UEs served by the second network node, respective Uu discontinuous reception (DRX) configuration of one or more candidate relay UEs served by the second network node, respective sidelink performance of one or more candidate relay UEs served by the second network node, or information regarding whether the second network node supports multipath communication involving relay UE.

In an embodiment, the first assistance information is sent to the first network node proactively and/or in response to a request from the first network node.

In an embodiment, respective RRC connected state of at least one candidate relay UE served by the second network node is comprised in the first assistance information or inferred by the first network node based on the first assistance information.

In an embodiment, when the first network node is responsible for selecting at least one indirect path for the UE served by the first network node to access the second network node, the method may further comprise receiving a third message from the first network node. The method may further comprise selecting a direct path and/or the at least one indirect path based on the third message. The method may further comprise sending a fourth message to the first network node. The fourth message may comprise at least one path for the UE to access the second network node. The third message may comprise at least one of respective identifier of at least one target relay UE of the at least one indirect path, an indication that a direct path and at least one indirect path are suitable for the UE to access the second network node, Uu performance of a direct path between the UE and the second network node, respective sidelink performance of at least one target relay UE of the at least one indirect path, a preference of direct path or indirect path, information regarding whether the UE supports multipath communication involving relay UE, or information regarding whether the UE demands to use multipath communication involving relay UE.

In an embodiment, selecting a direct path and/or the at least one indirect path based on the third message may comprise: when the third message comprises a preference of direct path or indirect path, checking whether a preferred path can be selected; when the preferred path can be selected, selecting the preferred path; and stopping checking other path.

In an embodiment, the method further comprise receiving the at least one path from the first network node.

In an embodiment, the method further comprise performing admission control at least for a selected direct path between the UE and the second network node.

In an embodiment, the method further comprise skipping admission control for at least one selected indirect path between the UE and the second network node.

In an embodiment, the at least one path may comprise at least one of at least one indirect path between the UE and the second network node, or a direct path between the UE and the second network node.

In an embodiment, the method further coordinating with the first network node to decide at least one of the first network node is responsible for selecting the at least one path for the UE to access the second network node, the second network node is responsible for selecting the at least one path for the UE to access the second network node, or the first network node is responsible for selecting at least one indirect path and the second network node is responsible for selecting a direct path and/or the at least one indirect path.

In a fifth aspect of the disclosure, there is provided a first network node. The first network node may comprise a processor and a memory coupled to the processor. Said memory contains instructions executable by said processor. Said first network node is operative to determine at least one candidate relay user equipment (UE) served by a second network node. Said first network node is further operative to send a first message comprising first information of the at least one candidate relay UE to the second network node. Said first network node is further operative to receive a second message from the second network node. The second message may comprise at least one path for the UE to access the second network node. Said first network node is further operative to send the at least one path to a UE served by the first network node to enable the UE to setup the at least one path. The at least one candidate relay UE is able to be used for establishing at least one indirect path between the UE and the second network node.

In a sixth aspect of the disclosure, there is provided a second network node. The second network node may comprise a processor and a memory coupled to the processor. Said memory contains instructions executable by said processor. Said second network node is operative to receive a first message comprising first information of at least one candidate relay UE served by the second network node from a first network node. Said second network node is further operative to select at least one path for a UE served by the first network node to access the second network node based on the first information and assistance information regarding the at least one candidate relay UE. Said second network node is further operative to send a second message to the first network node. The second message may comprise the at least one path for the UE to access the second network node. The at least one candidate relay UE is able to be used for establishing at least one indirect path between the UE and the second network node.

In a seventh aspect of the disclosure, there is provided a first network node. The first network node may comprise a processor and a memory coupled to the processor. Said memory contains instructions executable by said processor. Said first network node is operative to receive first assistance information regarding one or more candidate relay UEs served by a second network node from the second network node. Said first network node is further operative to determine at least one candidate relay UE served by the second network node. Said first network node is further operative to select at least one path for a UE served by the first network node to access the second network node based on at least one of the first assistance information, the at least one candidate relay UE, respective sidelink performance of the at least one candidate relay UE obtained from the UE, or respective radio resource control (RRC) connected state of the at least one candidate relay UE. The at least one candidate relay UE is able to be used for establishing at least one indirect path between the UE and the second network node.

In an eighth aspect of the disclosure, there is provided a second network node. The second network node may comprise a processor and a memory coupled to the processor. Said memory contains instructions executable by said processor. Said second network node is operative to send first assistance information regarding one or more candidate relay UEs served by the second network node to a first network node. The first assistance information is used for selecting at least one path for a UE served by the first network node to access the second network node.

In another aspect of the disclosure, there is provided a first network node. The first network node may comprise a first determining module configured to determine at least one candidate relay user equipment (UE) served by a second network node. The first network node further may comprise a first sending module configured to send a first message comprising first information of the at least one candidate relay UE to the second network node. The first network node further may comprise a receiving module configured to receive a second message from the second network node. The second message may comprise at least one path for the UE to access the second network node. The first network node further may comprise a second sending module configured to send the at least one path to a UE served by the first network node to enable the UE to setup the at least one path. The at least one candidate relay UE is able to be used for establishing at least one indirect path between the UE and the second network node.

In an embodiment, the first network node may further comprise a coordinating module configured to coordinate with the second network node to decide at least one of the first network node is responsible for selecting the at least one path for the UE to access the second network node, the second network node is responsible for selecting the at least one path for the UE to access the second network node, or the first network node is responsible for selecting at least one indirect path and the second network node is responsible for selecting a direct path and/or the at least one indirect path.

In another aspect of the disclosure, there is provided a second network node. The second network node may comprise a receiving module configured to receive a first message comprising first information of at least one candidate relay UE served by the second network node from a first network node. The second network node further may comprise a selecting module configured to select at least one path for a UE served by the first network node to access the second network node based on the first information and assistance information regarding the at least one candidate relay UE. The second network node further may comprise a sending module configured to send a second message to the first network node. The second message may comprise the at least one path for the UE to access the second network node

In an embodiment, the second network node may further comprise a coordinating module configured to coordinate with the first network node to decide at least one of the first network node is responsible for selecting the at least one path for the UE to access the second network node, the second network node is responsible for selecting the at least one path for the UE to access the second network node, or the first network node is responsible for selecting at least one indirect path and the second network node is responsible for selecting a direct path and/or the at least one indirect path.

In another aspect of the disclosure, there is provided a first network node. The first network node may comprise a first receiving module configured to receive first assistance information regarding one or more candidate relay UEs served by a second network node from the second network node. The first network node further may comprise a first determining module configured to determine at least one candidate relay UE served by the second network node. The first network node further may comprise a selecting module configured to select at least one path for a UE served by the first network node to access the second network node based on at least one of the first assistance information, first information of the at least one candidate relay UE, or respective radio resource control (RRC) connected state of the at least one candidate relay UE. The at least one candidate relay UE is able to be used for establishing at least one indirect path between the UE and the second network node.

In an embodiment, the first network node may further comprise a second receiving module configured to receive respective second assistance information from at least one third network node. The first network node may further comprise a second determining module configured to determine the second network node based on the respective second assistance information and the first assistance information. Second assistance information from a third network node may comprise assistance information regarding one or more candidate relay UEs served by the third network node.

In an embodiment, when the first network node is responsible for selecting at least one indirect path for the UE served by the first network node to access the second network node, the first network node may further comprise a first sending module configured to send a third message to the second network node. The first network node may further comprise a third receiving module configured to receive a fourth message from the second network node. The fourth message may comprise at least one path for the UE to access the second network node. The third message may comprise at least one of respective identifier of at least one target relay UE of the at least one indirect path, an indication that a direct path and at least one indirect path are suitable for the UE to access the second network node, Uu performance of a direct path between the UE and the second network node, respective sidelink performance of at least one target relay UE of the at least one indirect path, a preference of direct path or indirect path, information regarding whether the UE supports multipath communication involving relay UE, or information regarding whether the UE demands to use multipath communication involving relay UE.

In an embodiment, the first network node may further comprise a coordinating module configured to coordinate with the second network node to decide at least one of the first network node is responsible for selecting the at least one path for the UE to access the second network node, the second network node is responsible for selecting the at least one path for the UE to access the second network node, or the first network node is responsible for selecting at least one indirect path and the second network node is responsible for selecting a direct path and/or the at least one indirect path.

In an embodiment, the first network node may further comprise a second sending module configured to send the at least one path to the UE to enable the UE to setup the at least one path.

In an embodiment, the first network node may further comprise a third sending module configured to send the at least one path to the second network node.

In another aspect of the disclosure, there is provided a second network node. The second network node may comprise a first sending module configured to send first assistance information regarding one or more candidate relay UEs served by the second network node to a first network node. The first assistance information is used for selecting at least one path for a UE served by the first network node to access the second network node.

In an embodiment, when the first network node is responsible for selecting at least one indirect path for the UE served by the first network node to access the second network node, the second network node may further comprise a first receiving module configured to receive a third message from the first network node. The second network node may further comprise a selecting module configured to select a direct path and/or the at least one indirect path based on the third message. The second network node may further comprise a second sending module configured to send a fourth message to the first network node. The fourth message may comprise at least one path for the UE to access the second network node. The third message may comprise at least one of respective identifier of at least one target relay UE of the at least one indirect path, an indication that a direct path and at least one indirect path are suitable for the UE to access the second network node, Uu performance of a direct path between the UE and the second network node, respective sidelink performance of at least one target relay UE of the at least one indirect path, a preference of direct path or indirect path, information regarding whether the UE supports multipath communication involving relay UE, or information regarding whether the UE demands to use multipath communication involving relay UE.

In an embodiment, the second network node may further comprise a second receiving module configured to receive the at least one path from the first network node.

In an embodiment, the second network node may further comprise a performing module configured to perform admission control at least for a selected direct path between the UE and the second network node.

In an embodiment, the second network node may further comprise a skipping module configured to skip admission control for at least one selected indirect path between the UE and the second network node.

In an embodiment, the second network node may further comprise a coordinating module configured to coordinate with the first network node to decide at least one of the first network node is responsible for selecting the at least one path for the UE to access the second network node, the second network node is responsible for selecting the at least one path for the UE to access the second network node, or the first network node is responsible for selecting at least one indirect path and the second network node is responsible for selecting a direct path and/or the at least one indirect path.

In another aspect of the disclosure, there is provided a computer program product comprising instructions which when executed by at least one processor, cause the at least one processor to perform the method according to any one of the first, second, third or fourth aspects.

In another aspect of the disclosure, there is provided a computer-readable storage medium storing instructions which when executed by at least one processor, cause the at least one processor to perform the method according to any one of the first, second, third or fourth aspects.

In another aspect of the disclosure, there is provided a communication system including a host computer. The host computer includes processing circuitry configured to provide user data and a communication interface configured to forward the user data to a cellular network for transmission to a terminal device. The cellular network includes the network node above mentioned first network node or second network node, and/or the terminal device (such as the UE and the relay UE above mentioned).

In embodiments of the present disclosure, the system further includes the terminal device. The terminal device is configured to communicate with the network node.

In embodiments of the present disclosure, the processing circuitry of the host computer is configured to execute a host application, thereby providing the user data; and the terminal device includes processing circuitry configured to execute a client application associated with the host application.

In another aspect of the disclosure, there is provided a communication system including a host computer and a network node. The host computer includes a communication interface configured to receive user data originating from a transmission from a terminal device. The transmission is from the terminal device to the network node. The network node is above mentioned, and/or the terminal device is above mentioned UE and relay UE.

In embodiments of the present disclosure, the processing circuitry of the host computer is configured to execute a host application. The terminal device is configured to execute a client application associated with the host application, thereby providing the user data to be received by the host computer.

In another aspect of the disclosure, there is provided a method implemented in a communication system which may include a host computer, a network node and a terminal device. The method may comprise providing user data at the host computer. Optionally, the method may comprise, at the host computer, initiating a transmission carrying the user data to the terminal device via a cellular network comprising the network node which may perform any step of the method according to the first or second aspects of the present disclosure.

In another aspect of the disclosure, there is provided a communication system including a host computer. The host computer may comprise processing circuitry configured to provide user data, and a communication interface configured to forward the user data to a cellular network for transmission to a terminal device. The cellular network may comprise a network node having a radio interface and processing circuitry. The network node's processing circuitry may be configured to perform any step of the method according to the first or second aspects of the present disclosure.

In another aspect of the disclosure, there is provided a method implemented in a communication system which may include a host computer, a network node and a terminal device. The method may comprise providing user data at the host computer. Optionally, the method may comprise, at the host computer, initiating a transmission carrying the user data to the terminal device via a cellular network comprising the network node.

In another aspect of the disclosure, there is provided a communication system including a host computer. The host computer may comprise processing circuitry configured to provide user data, and a communication interface configured to forward user data to a cellular network for transmission to a terminal device. The terminal device may comprise a radio interface and processing circuitry.

In another aspect of the disclosure, there is provided a method implemented in a communication system which may include a host computer, a network node and a terminal device. The method may comprise, at the host computer, receiving user data transmitted to the network node from the terminal device.

In another aspect of the disclosure, there is provided a communication system including a host computer. The host computer may comprise a communication interface configured to receive user data originating from a transmission from a terminal device to a network node. The terminal device may comprise a radio interface and processing circuitry.

In another aspect of the disclosure, there is provided a method implemented in a communication system which may include a host computer, a network node and a terminal device. The method may comprise, at the host computer, receiving, from the network node, user data originating from a transmission which the network node has received from the terminal device. The network node may perform any step of the method according to the first or second aspects of the present disclosure.

In another aspect of the disclosure, there is provided a communication system which may include a host computer. The host computer may comprise a communication interface configured to receive user data originating from a transmission from a terminal device to a network node. The network node may comprise a radio interface and processing circuitry. The network node's processing circuitry may be configured to perform any step of the method according to the first or second aspects of the present disclosure.

Embodiments herein may provide many advantages, of which a non-exhaustive list of examples follows. In some embodiments herein, the performance of inter-network node path switching can be improved due to that selection of indirect path is more accurate. In some embodiments herein, the benefits can be achieved in both single path scenario and multipath scenario. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1a illustrates User Plane Stack for L2 UE-to-Network Relay UE according to an embodiment of the present disclosure;

FIG. 1b illustrates Control Plane for L2 UE-to-Network Relay UE according to an embodiment of the present disclosure;

FIG. 1c shows intra-gNB path switching procedure from indirect path to direct path according to an embodiment of the present disclosure;

FIG. 1d shows intra-gNB path switching procedure from direct path to indirect path according to an embodiment of the present disclosure;

FIG. 2a schematically shows a high level architecture in the fifth generation network according to an embodiment of the present disclosure;

FIG. 2b schematically shows system architecture in a 4G network according to an embodiment of the present disclosure;

FIG. 3a shows a flowchart of a method according to an embodiment of the present disclosure;

FIG. 3b shows a flowchart of a method according to another embodiment of the present disclosure;

FIG. 4a shows a flowchart of a method according to another embodiment of the present disclosure;

FIG. 4b shows a flowchart of a method according to another embodiment of the present disclosure;

FIG. 5a shows a flowchart of a method according to another embodiment of the present disclosure;

FIG. 5b shows a flowchart of a method according to another embodiment of the present disclosure;

FIG. 5c shows a flowchart of a method according to another embodiment of the present disclosure;

FIG. 5d shows a flowchart of a method according to another embodiment of the present disclosure;

FIG. 5e shows a flowchart of a method according to another embodiment of the present disclosure;

FIG. 6a shows a flowchart of a method according to another embodiment of the present disclosure;

FIG. 6b shows a flowchart of a method according to another embodiment of the present disclosure;

FIG. 6c shows a flowchart of a method according to another embodiment of the present disclosure;

FIG. 6d shows a flowchart of a method according to another embodiment of the present disclosure;

FIG. 7 is a block diagram showing an apparatus suitable for practicing some embodiments of the disclosure;

FIG. 8a is a block diagram showing a first network node according to an embodiment of the disclosure;

FIG. 8b is a block diagram showing a second network node according to an embodiment of the disclosure;

FIG. 8c is a block diagram showing a first network node according to another embodiment of the disclosure;

FIG. 8d is a block diagram showing a second network node according to another embodiment of the disclosure;

FIG. 9 is a schematic showing a wireless network in accordance with some embodiments;

FIG. 10 is a schematic showing a user equipment in accordance with some embodiments;

FIG. 11 is a schematic showing a virtualization environment in accordance with some embodiments;

FIG. 12 is a schematic showing a telecommunication network connected via an intermediate network to a host computer in accordance with some embodiments;

FIG. 13 is a schematic showing a host computer communicating via a base station with a user equipment over a partially wireless connection in accordance with some embodiments;

FIG. 14 is a schematic showing methods implemented in a communication system including a host computer, a base station and a user equipment in accordance with some embodiments;

FIG. 15 is a schematic showing methods implemented in a communication system including a host computer, a base station and a user equipment in accordance with some embodiments;

FIG. 16 is a schematic showing methods implemented in a communication system including a host computer, a base station and a user equipment in accordance with some embodiments; and

FIG. 17 is a schematic showing methods implemented in a communication system including a host computer, a base station and a user equipment in accordance with some embodiments.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced (LTE-A), wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network node” or “network node” refers to any suitable network function (NF) which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The network node may be an access network node with accessing function in a communication network via which a terminal device accesses to the network and receives services therefrom. The access network node may include a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), an Integrated Access and Backhaul (IAB) node, a remote radio head (RRH), a relay, a low power node such as a femto, a pico, and so forth.

Yet further examples of the access network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second clement could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for case of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

### Sidelink Transmissions in NR

3GPP specified the LTE D2D (device-to-device) technology, also known as sidelink (SL) or the PC5 interface as part of 3GPP Release 12 (Rel-12). The target use cases (UC) were the Proximity Services (communication and discovery). Support for such services was enhanced in 3GPP Rel-13 and in 3GPP Rel-14. In 3GPP Rel-14, the LTE sidelink was extensively redesigned to support vehicular communications (commonly referred to as vehicle-to-everything (V2X) or vehicle-to-vehicle (V2V). Support was again enhanced during 3GPP Release 15. From the point of view of the lowest radio layers, the LTE SL uses broadcast communication. That is, transmission from a UE targets any receiver that is in range.

ProSe (Proximity Services) in the 3GPP Release 12 and 13 of LTE. Later in 3GPP Rel. 14 and 15, LTE V2X related enhancements targeting the specific characteristics of vehicular communications were specified. In LTE V2X only broadcast is supported over sidelink.

In 3GPP Release 16, 3GPP introduced the sidelink for the 5G new radio (NR). The driving UC were vehicular communications with more stringent requirements than those typically served using the LTE SL. To meet these requirements, the NR SL is capable of broadcast, groupcast, and unicast communications. In groupcast communication, the intended receivers of a message are typically a subset of the vehicles near the transmitter, whereas in unicast communication, there is a single intended receiver.

Both the LTE SL and the NR SL can operate with and without network coverage and with varying degrees of interaction between the UEs (user equipment) and the NW (network), including support for standalone, network-less operation.

In 3GPP Rel. 17, public safety was one of the most important use cases, which can benefit from the already developed NR sidelink features in 3GPP Rel. 16. Therefore, 3GPP specified enhancements related to public safety use cases taking the NR Rel. 16 sidelink as the baseline. Besides, in some scenarios public safety services need to operate with partial or w/o NW coverage, such as during indoor firefighting, forest firefighting, earthquake rescue, sea rescue, etc. where the infrastructure is (partially) destroyed or not available, therefore, coverage extension is a crucial enabler for public safety, for both services communicated between UE and cellular NW and that communicated between UEs over sidelink. In 3GPP Rel. 17, a SID (sidelink identifier) on NR sidelink relay (RP-193253) was introduced which aims to further explore coverage extension for sidelink-based communication, including both UE to NW relay for cellular coverage extension and UE to UE relay for sidelink coverage extension. Now the work has proceeded to normative phase and in the WID (Work Item Description) only UE to NW relay is considered. In addition to public safety use-cases, the NR sidelink relay WI is also designed to support other commercial use-cases which would also greatly benefit from the coverage extension. Two solutions for UE to NW relaying were specified namely Layer-2 (L2) UE-to-NW relaying and Layer-3 (L3) UE-to-NW relaying.

### Layer 2 UE-to-Network Relay

In 3GPP TR 23.752 V17.0.0, the disclosure of which is incorporated by reference herein in its entirety, the layer-2 (L2) based UE-to-Network relay (U2N) is described.

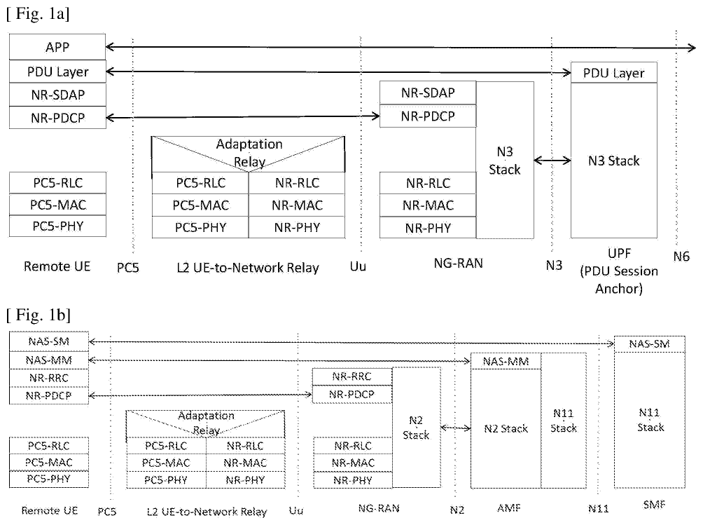

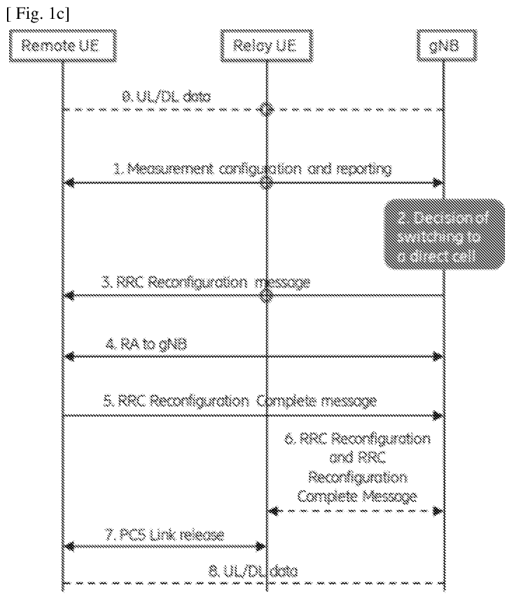

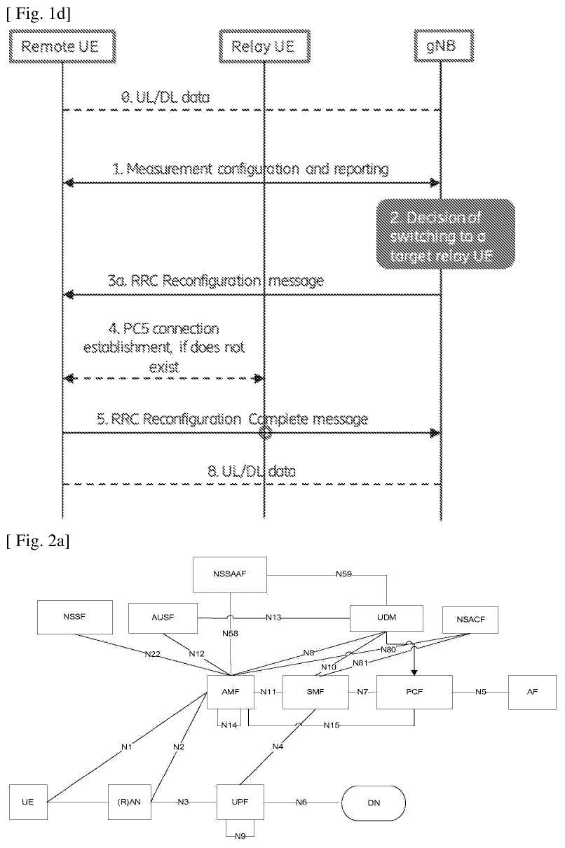

FIG. 1a illustrates User Plane Stack for L2 UE-to-Network Relay UE according to an embodiment of the present disclosure. PDU denotes Protocol Data Unit. SDAP denotes Service Data Adaptation Protocol. RLC denotes Radio Link Control. MAC denotes Medium Access Control. PHY denotes physical. L2 denotes layer 2.

The L2 UE-to-Network Relay UE provides forwarding functionality that can relay any type of traffic over the PC5 link.

The L2 UE-to-Network Relay UE provides the functionality to support connectivity to the 5GS for Remote UEs. A UE is considered to be a Remote UE if it has successfully established a PC5 link to the L2 UE-to-Network Relay UE. A Remote UE can be located within NG-RAN coverage or outside of NG-RAN coverage.

The PDU (protocol data unit) layer corresponds to the PDU carried between the Remote UE and the Data Network (DN) over the PDU session. The PDU layer corresponds to the PDU carried between the Remote UE and the Data Network (DN) over the PDU session. It is important to note that the two endpoints of the packet data convergence protocol (PDCP) layer link are the Remote UE and the gNB. The relay function is performed below PDCP. This means that data security is ensured between the Remote UE and the gNB without exposing raw data at the UE-to-Network Relay UE.

The adaptation layer within the UE-to-Network Relay UE can differentiate between signaling radio bearers (SRBs) and data radio bearers (DRBs) for a particular Remote UE. The adaption relay layer is also responsible for mapping the SRBs and DRBs of the remote UE to one or more RLC channels of the Uu link and one or more PC5 RLC channels of the PC5 link.

FIG. 1b illustrates Control Plane for L2 UE-to-Network Relay UE according to an embodiment of the present disclosure. NAS denotes Non-Access Stratum. SM denotes Session Management. MM denotes Mobility Management.

The NAS messages are transparently transferred between the Remote UE and 5G-AN (access network) over the Layer 2 UE-to-Network Relay UE using:
PDCP end-to-end connection where the role of the UE-to-Network Relay UE is to relay the PDUs over the signaling radio bear without any modifications.
N2 connection between the 5G-AN and AMF over N2.
N3 connection AMF and SMF over N11.

The role of the UE-to-Network Relay UE is to relay the PDUs from the signaling radio bearer without any modifications.

### Path Switch Procedure

Only intra-gNB path switching between indirect path and direct path is supported in 3GPP Rel. 17.

FIG. 1c shows intra-gNB path switching procedure from indirect path to direct path according to an embodiment of the present disclosure.

Step 0: uplink (UL)/downlink (DL) data is transmitted one the indirect path.

Step 1: gNB sends measurement configuration to the remote UE and the remote UE reports the measurement result to gNB.

Step 2: gNB makes a decision of switching to a direct path.

Step 3: gNB sends radio resource control (RRC) Reconfiguration message to the remote UE.

Step 4: Remote UE performs Random Access to the gNB.

Step 5: Remote UE sends RRC Reconfiguration Complete message to gNB via direct path, using the configuration provided in the RRC Reconfiguration message.

Step 6: gNB sends RRC Reconfiguration message to relay UE and relay UE sends RRC Reconfiguration complete message to gNB.

Step 7: The PC5 link is released between Remote UE and the Relay UE, if needed.

Step 8: The data path switches from indirect path to direct path.

NOTE: The order of step 6/7/8 is not restricted. Following are further discussed in 3GPP WI (work item) phase, including:
Whether Remote UE suspends data transmission via relay link after step 3;
Whether Step 6 can be before or after step 3 and its necessity;
Whether Step 7 can be after step 3 or step 5, and its necessity/replaced by PC5 reconfiguration;
Whether Step 8 can be after step 5.

FIG. 1d shows intra-gNB path switching procedure from direct path to indirect path according to an embodiment of the present disclosure.

Step 0: uplink (UL)/downlink (DL) data is transmitted one the direct path.

Step 1: gNB sends measurement configuration to the remote UE and the remote UE reports the measurement result to gNB. For example, Remote UE reports one or multiple candidate Relay UE(s), after Remote UE measures/discoveries the candidate Relay UE(s).

Remote UE may filter the appropriate Relay UE(s) meeting higher layer criteria when reporting, in step 1.

The reporting may include the Relay UE's ID and SL Reference Signal Received Power (RSRP) information.

Step 2: gNB makes a decision of switching to a target Relay UE, and target (re) configuration is sent to Relay UE optionally (like preparation).

Step 3a: gNB sends RRC Reconfiguration message to Remote UE. Following information may be included: 1) Identity of the target Relay UE; 2) Target Uu and PC5 configuration.

Step 4: Remote UE establishes PC5 connection with target Relay UE, if the connection has not been setup yet.

Step 5: Remote UE sends the RRC Reconfiguration Complete message to gNB via indirect path, using the target configuration provided in the RRC Reconfiguration message.

Step 6: The data path switching from direct path to indirect path.

NOTE: Following are further discussed in 3GPP WI phase, including:
Whether Step 2 should be after Relay UE connects to the gNB (e.g. after step 4), if not yet before;
Whether Step 4 can be before step 2/3.

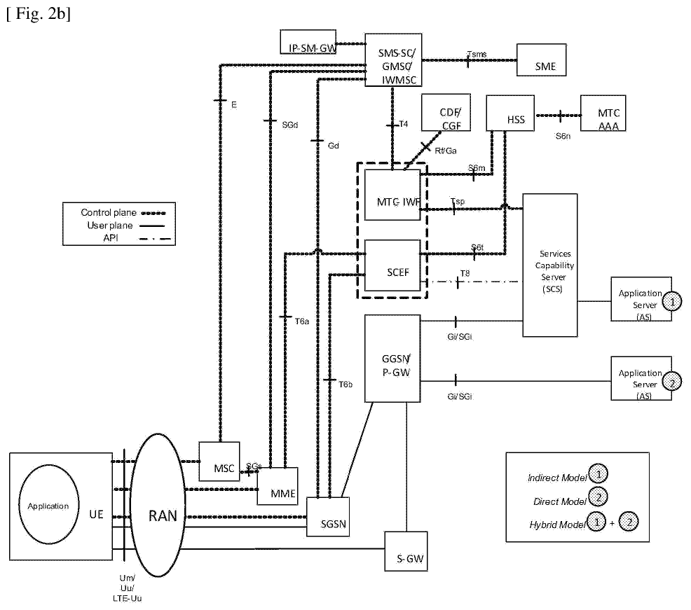

Although the subject matter described herein may be implemented in any appropriate type of system using any suitable components, the embodiments disclosed herein are described in relation to a communication system complied with the exemplary system architectures illustrated in FIGS. 2a-2b. For simplicity, the system architectures of FIGS. 2a-2b only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

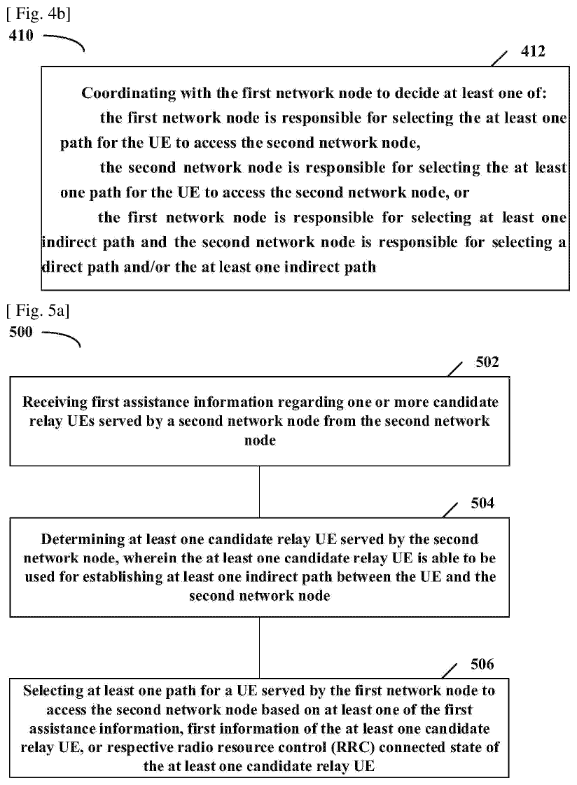

FIG. 2a schematically shows a high level architecture in the fifth generation network according to an embodiment of the present disclosure. For example, the fifth generation network may be 5GS. The architecture of FIG. 2a is same as FIG. 4.2.3-2 as described in 3GPP TS 23.501 V17.2.0, the disclosure of which is incorporated by reference herein in its entirety. The system architecture of FIG. 2a may comprise some exemplary elements such as AUSF, AMF, DN (data network), NEF, NRF, NSSF, PCF, SMF, UDM, UPF, AF, UE, (R) AN, SCP (Service Communication Proxy), NSSAAF (Network Slice-Specific Authentication and Authorization Function), NSACF (Network Slice Admission Control Function), etc.

In accordance with an exemplary embodiment, the UE can establish a signaling connection with the AMF over the reference point N1, as illustrated in FIG. 2a. This signaling connection may enable NAS (Non-access stratum) signaling exchange between the UE and the core network, comprising a signaling connection between the UE and the (R) AN and the N2 connection for this UE between the (R) AN and the AMF. The (R) AN can communicate with the UPF over the reference point N3. The UE can establish a protocol data unit (PDU) session to the DN (data network, e.g. an operator network or Internet) through the UPF over the reference point N6.

As further illustrated in FIG. 2a, the exemplary system architecture also contains some reference points such as N1, N2, N3, N4, N6, N9, N15, etc., which can support the interactions between NF services in the NFs. For example, these reference points may be realized through corresponding NF service-based interfaces and by specifying some NF service consumers and providers as well as their interactions in order to perform a particular system procedure. The AM related policy is provided by PCF to AMF for a registered UE via N15 interface. AMF can get AM policy during AM Policy Association Establishment/Modification procedure.

Various NFs shown in FIG. 2a may be responsible for functions such as session management, mobility management, authentication, security, etc. The AUSF, AMF, DN, NEF, NRF, NSSF, PCF, SMF, UDM, UPF, AF, UE, (R) AN, SCP, NSACF may include the functionality for example as defined in clause 6.2 of 3GPP TS 23.501 V17.2.0.

FIG. 2b schematically shows system architecture in a 4G network according to an embodiment of the present disclosure, which is the same as FIG. 4.2-1a of 3GPP TS 23.682 V17.2.0, the disclosure of which is incorporated by reference herein in its entirety. The system architecture of FIG. 2b may comprise some exemplary elements such as Services Capability Server (SCS), Application Server (AS), SCEF (Service Capability Exposure Function), HSS, UE, RAN (Radio Access Network), SGSN (Serving GPRS (General Packet Radio Service) Support Node), MME, MSC (Mobile Switching Centre), S-GW (Serving Gateway), GGSN/P-GW (Gateway GPRS Support Node/PDN (Packet Data Network) Gateway), MTC-IWF (Machine Type Communications-InterWorking Function) CDF/CGF (Charging Data Function/Charging Gateway Function), MTC-AAA (Machine Type Communications-authenti cation, authorization and accounting), SMS-SC/GMSC/IWMSC (Short Message Service-Service Centre/Gateway MSC/InterWorking MSC) IP-SM-GW (Internet protocol Short Message Gateway). The network elements and interfaces as shown in FIG. 2b may be same as the corresponding network elements and interfaces as described in 3GPP TS 23.682 V17.2.0.

The system architecture shows the architecture for a UE used for MTC connecting to the 3GPP network (UTRAN (Universal Terrestrial Radio Access Network), E-UTRAN (Evolved UTRAN), GERAN (GSM EDGE (Enhanced Data rates for GSM Evolution) Radio Access Network), etc.) via the Um/Uu/LTE-Uu interfaces. The system architecture also shows the 3GPP network service capability exposure to SCS and AS.

As further illustrated in FIG. 2b, the exemplary system architecture also contains various reference points.

Tsms: Reference point used by an entity outside the 3GPP network to communicate with UEs used for MTC via SMS (Short Message Service).

Tsp: Reference point used by a SCS to communicate with the MTC-IWF related control plane signalling.

T4: Reference point used between MTC-IWF and the SMS-SC in the HPLMN.

T6a: Reference point used between SCEF and serving MME.

T6b: Reference point used between SCEF and serving SGSN.

T8: Reference point used between the SCEF and the SCS/AS.

S6m: Reference point used by MTC-IWF to interrogate HSS/HLR (Home Location Register).

S6n: Reference point used by MTC-AAA to interrogate HSS/HLR.

S6t: Reference point used between SCEF and HSS.

SGs: Reference point used between MSC and MME.

Gi/SGi: Reference point used between GGSN/P-GW and application server and between GGSN/P-GW and SCS.

Rf/Ga: Reference point used between MTC-IWF and CDF/CGF.

Gd: Reference point used between SMS-SC/GMSC/IWMSC and SGSN.

SGd: Reference point used between SMS-SC/GMSC/IWMSC and MME.

E: Reference point used between SMS-SC/GMSC/IWMSC and MSC.

A term “node” is used, which can be a network node or a UE. Examples of network nodes are NodeB, base station (BS), multi-standard radio (MSR) radio node such as MSR BS, eNodeB, gNodeB, MeNB (Master eNB), SeNB (Secondary eNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN (Centralized-RAN), access point (AP), transmission points, transmission nodes, Remote Radio Unit (RRU), Remote Radio Head (RRH), nodes in distributed antenna system (DAS), core network node (e.g. MSC, MME etc), O&M (Operations & Maintenance), Operation Support System (OSS), Self-Organizing Networks (SON), positioning node (e.g. E-SMLC (Evolved Serving Mobile Location Centre)), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, Tablet, mobile terminals, smart phone, laptop embedded equipment (LEE), laptop mounted equipment (LME), USB dongles etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP) etc.

The term radio access technology, or RAT, may refer to any RAT e.g. UTRA, E-UTRA, narrow band internet of things (NB-IoT), WiFi, Bluetooth, next generation RAT, New Radio (NR), 4G, 5G, etc. Any of the equipment denoted by the terminology node, network node or radio network node may be capable of supporting a single or multiple RATs.

The embodiments are described in the context of NR, i.e., two or more SL UEs are deployed in a same or different NR cell. However, the same principle may be applied to LTE or any other technology that enables the direct connection of two (or more) nearby devices. The embodiments are also applicable to relay scenarios including UE to network relaying and/or UE to UE relaying where the remote UE and the relay UE may be based on LTE sidelink or NR sidelink, the Uu connection between the relay UE and the base station may be LTE Uu or NR Uu. The embodiments are applicable to L2 based U2N relaying scenarios.

The methods and solution disclosed in the following, are referring to the NR RAT but can be applied also to LTE RAT and any other RAT enabling the direct transmission between two (or more) nearby devices without any loss of meaning.

The link or radio link over which the signals are transmitted between at least two UEs for D2D operation is called herein as the sidelink (SL). The signals transmitted between the UEs for D2D operation are called herein as SL signals. The term SL may also interchangeably be called as D2D link, V2X link, prose link, peer-to-peer link, PC5 link etc. The SL signals may also interchangeably be called as V2X signals, D2D signals, prose signals, PC5 signals, peer-to-peer signals etc.

The term direct link/connection/path refers to a link/connection between a (remote) UE and base station (gNB) over the Uu (NR/LTE) interface. The term indirect link/connection refers to a link/connection between a (remote) UE and base station (gNB) via a relay UE i.e., the connection/link between the (remote) UE and relay UE is over the PC5 interface and that between the relay UE and base station (gNB) is over the Uu interface.

The terms multipath operation/connection with relays and multipath operation/connection are often used inter-changeably. In addition, when referring to a multipath operation with relays/multipath operation, we refer to all the operations possible i.e., utilizing multiple paths simultaneously (for e.g., duplication of packets or data splitting for higher throughput/reliability over multiple paths) or switching among multiple paths. This basically means that a UE keeps two path, link, bearers, or connections active at the same time.

The embodiments are written from the perspective of a (remote) UE, a relay UE, a source network node, neighboring network node and a target network node. The (remote) UE is initially under the coverage of a source network node and subsequently performs a HO/path switch to a target network node using multipath relay configurations.

The source/target network node can comprise multiple cells that the (remote) UE can see. For simplicity, the description below is written such that the (remote) UE performs a HO/path switch from a cell in the source network node to a cell in the target network node. As a result, in the description below, cells/network node are used interchangeably.

As used herein, the term “Uu interface” may be referred to as the radio interface between a terminal device and a network node (such as base station, gNB, eNB, etc.). The term “PC5 interface” may be referred to as the radio interface between any two terminal devices.

The embodiments apply to L2 UE to NW relay.

The embodiments below are not restricted by any term defined in the above texts. Any other similar term is inter-changeably where applicable here without any loss of the meaning.

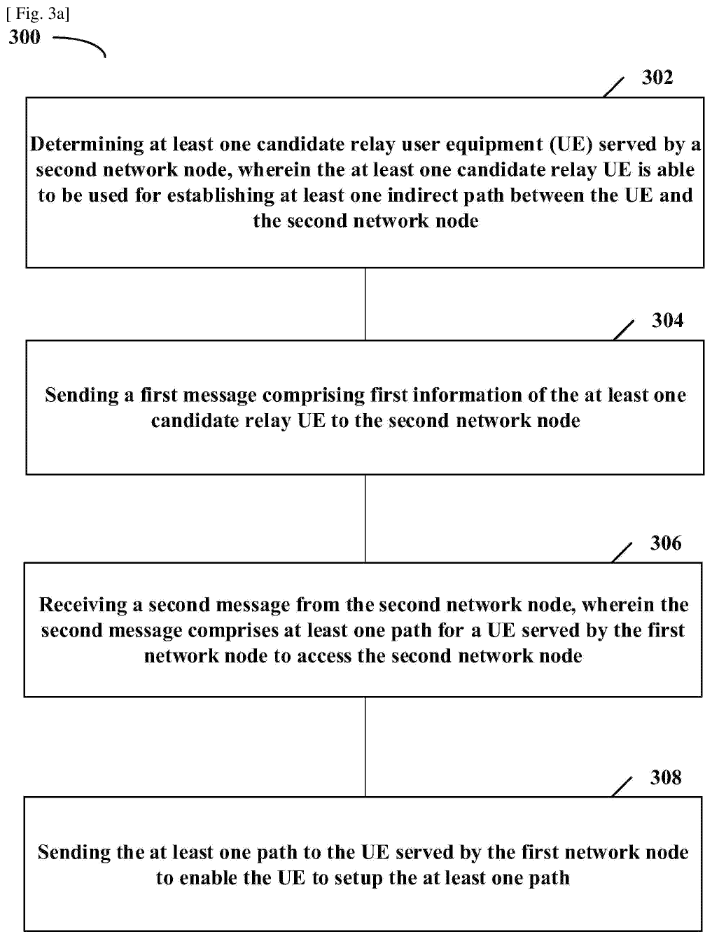

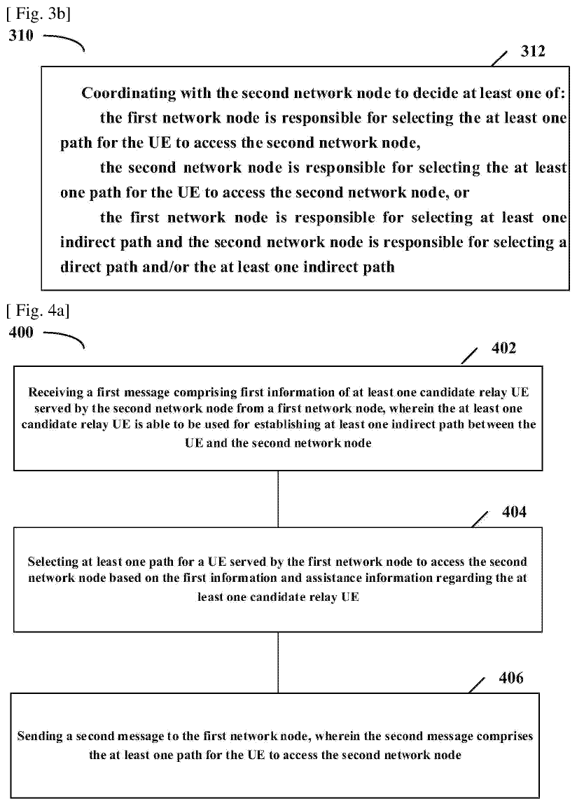

FIG. 3a shows a flowchart of a method according to an embodiment of the present disclosure, which may be performed by an apparatus implemented in or at or as a first network node or communicatively coupled to the first network node. As such, the apparatus may provide means or modules for accomplishing various parts of the method 300 as well as means or modules for accomplishing other processes in conjunction with other components.

At block 302, the first network node may determine at least one candidate relay user equipment (UE) served by a second network node.

The at least one candidate relay UE is able to be used for establishing at least one indirect path between a UE served by the first network node and the second network node.

The second network node may be a target network node. The first network node may be a source network node. For example, a handover/path switch procedure may be used to hand over the UE from the first network node to the second network node.

The first network node can communicate with the second network node via a direct link or an indirect link. For example, the second network node and the first network node can communicate with each other using the Xn reference point or X2 interface.

In an embodiment, the first and second network node may belong to the same network. In other embodiments, the first and second network node may belong to different network. In an embodiment, the first and second network node may connect to the same core network node.

The first network node may determine the second network node in various ways. For example, the first network node may determine the second network node based on a measurement report of the UE and/or other UEs. The first network node may determine the second network node based on the location information of the second network node and the UE. The first network node may determine the second network node based on machine learning.

In an embodiment, a handover/path switch procedure used to hand over the UE from the first network node to the second network node is to be performed. The handover/path switch procedure may be any suitable handover/path switch procedure for example as defined in various 3GPP specifications, such as 3GPP TS 23.401 V17.3.0, 3GPP TS 23.502 V17.1.1, 3GPP TR 23.752 V17.0.0, etc.

The handover/path switch procedure can be triggered due to various reasons. For example, the handover/path switch procedure can be triggered due to new radio conditions, load balancing or due to specific service e.g. in the presence of QoS low for voice.

The first network node may determine at least one candidate relay UE served by the second network node in various ways. For example, a remote UE served by the first network node may discover one or more candidate relay UEs which may be severed by one or more network nodes in the vicinity of the UE and then report the discovered one or more candidate relay UEs (possibility with their cell information or identifiers, etc.) to the first network node. Then the first network node may determine at least one candidate relay UE served by the second network node reported by the UE.

At block 304, the first network node may send a first message comprising first information of the at least one candidate relay UE to the second network node.

The first message may be any suitable message and the present disclosure has no limit on it. For example, the first message may be a path switching request or a handover request or a path determination request.

The first information of the at least one candidate relay UE may comprise any suitable information related to the at least one candidate relay UE. For example, the first information may comprise an identifier of candidate relay UE, capability of candidate relay UE, battery information of candidate relay UE, load information (such as relay load) of candidate relay UE, Uu performance of candidate relay UE, sidelink performance of candidate relay UE, etc.

In an embodiment, the first information may comprise at least one of respective identifier of the at least one candidate relay UE, or respective sidelink performance of the at least one candidate relay UE.

For example, when performing path switching or handover procedure for a remote UE, the source network node serving the remote UE determines at least one candidate relay UE served by a different network node, and sends a signaling (e.g., path switching request) to at least one of the different network nodes. The signaling may include one or more of the following information:
The at least one candidate relay UE served by that network node,
The PC5 performance of the at least one candidate relay UE, e.g., the measured PC5 RSRP (Reference Signal Received Power) to the remote UE which may be obtained from the remote UE's measurement report.

The network node serving the at least one candidate relay UE then selects a target relay UE from the at least one candidate relay UE based on one or more of the following information:
The Uu performance (e.g., Uu RSRP to network node, Uu traffic load, etc.) of the candidate relay UE(s),
The capability of the candidate relay UE(s) i.e., whether the relay UE can support features like Carrier aggregation (CA)/dual connectivity (DC)/dual active protocol stack (DAPS),
The Uu DRX configuration of the candidate relay UE(s),
The RRC state of the candidate relay UE(s). The network node can know whether a candidate relay UE is in RRC connected by checking whether the candidate relay UE has a RRC connection to the network node,
The PC5 performance of the candidate relay UE(s) obtained from the source network node serving the remote UE (e.g., PC5 RSRP to the remote UE),
The PC5 performance of the candidate relay UE(s) obtained from e.g., the candidate relay UE(s) (e.g., PC5 traffic load, number of remote UE(s) currently being served by the candidate relay UE

In case at least one target relay UE is selected from the at least one candidate relay UE, the target network node informs the selected at least one target relay UE to the source network node in e.g., path switching request Ack. The source network node then informs the selected at least one target relay UE to the remote UE in e.g., RRCReconfiguration message.

In an embodiment, the first information may comprise at least one of respective identifier of the at least one candidate relay UE, respective sidelink performance of the at least one candidate relay UE, an indication that a direct path and at least one indirect path are suitable for the UE to access the second network node, Uu performance of a direct path between the UE and the second network node, a preference of direct path or indirect path, information regarding whether the UE supports multipath communication involving relay UE, or information regarding whether the UE demands to use multipath communication involving relay UE.

The identifier of a candidate relay UE may be any suitable identifier such that the second network node can identify the candidate relay UE.

The sidelink performance of a candidate relay UE may comprise any suitable information related to the sidelink information, such as sidelink RSRP to the remote UE obtained from the remote UE's measurement report, sidelink relay load of the candidate relay UE obtained from the candidate relay UE, etc.

The first network node can determine that a direct path and at least one indirect path are suitable for the UE to access the second network node. For example, the UE may report the Uu performance of the direct path, and based on the Uu performance of the direct path, the first network node can determine that a direct path is suitable for the UE to access the second network node. In addition, the first network node can determine that at least one indirect path are suitable for the UE to access the second network node based on the first information.

Uu performance of a direct path between the UE and the second network node may be measured Uu RSRP between the UE and the second network node obtained from the UE's measurement report.

The preference of direct path or indirect path may be obtained from the UE. Alternatively the first network node may determine the preference of direct path or indirect path for example based on service type, candidate relay UE load, the second network node load, etc.

The information regarding whether the UE supports multipath communication involving relay UE and/or the information regarding whether the UE demands to use multipath communication involving relay UE can be obtained from the UE or determined by the first network node for example based on the capability of the UE.

For example, when both direct path and at least one indirect path are suitable to be used for a remote UE to access the target network node, the source network node sends a signaling (e.g., path switching request) to the target network node where the signaling includes one or more of the following info:
Both direct path and at least one indirect path are suitable for the remote UE to access the target network node,
The at least one candidate relay UE of the at least one indirect path,
The Uu performance of the direct path, e.g., the measured Uu RSRP between the target network node and the remote UE obtained from the remote UE's measurement report,
The PC5 performance of the candidate relay UE(s), e.g., the measured PC5 RSRP to the remote UE obtained from the remote UE's measurement report,
Preference of different kinds of path, e.g., whether direct path or indirect path is preferred,
The remote UE's capability on supporting of multipath communication involving relay UE,
The remote UE's demand for use of multipath communication involving relay UE.

The target network node then determines whether to select the direct path and/or at least one target relay UE from the at least one candidate relay UE based on above info. In case the source network node provides the preference of different kinds of path, the target network node may first check whether the preferred path can be selected. if the preferred path can be selected, the target network node may select the preferred path and stop checking the other path(s). In case a path is selected, the target network node informs the selected path to the source network node in e.g., path switching request Ack. In case indirect path is selected, the target network node further informs the selected target relay UE(s).

In case the source network node indicates that the remote UE supports/wants to apply multipath communication involving relay UE, the target network node selects one or more target relay UE(s) and checks whether multipath communication can be configured for the remote UE via the direct path and the selected target relay UE(s). Alternatively the target network node selects two or more target relay UEs and checks whether multipath communication can be configured for the remote UE via the selected target relay UEs. In case multipath communication is configured for the remote UE, the target network node informs this to the source network node together with the associated paths (where indirect path is represented by the associated target relay UE).

At block 306, the first network node may receive a second message from the second network node. The second message may comprise at least one path for the UE to access the second network node.

The second message may be any suitable message and the present disclosure has no limit on it. In an embodiment, the second message may be a path switching request Ack.

The path may be represented in various ways. For example, the direct path may be represent by a bit, a flag, an indication, etc. The indirect path may be represented by the associated target relay UE.

In an embodiment, the at least one path may comprise at least one of at least one indirect path between the UE and the second network node, or a direct path between the UE and the second network node.

At block 308, the first network node may send the at least one path to the UE served by the first network node to enable the UE to setup the at least one path.

For example, the first network node may inform the selected target relay UE(s) to the remote UE in e.g., RRCReconfiguration message. The first network node may inform direct path to the remote UE in e.g., RRCReconfiguration message.

FIG. 3b shows a flowchart of a method according to another embodiment of the present disclosure, which may be performed by an apparatus implemented in or at or as a first network node or communicatively coupled to the first network node. As such, the apparatus may provide means or modules for accomplishing various parts of the method 310 as well as means or modules for accomplishing other processes in conjunction with other components. For some parts which have been described in the above embodiments, the description thereof is omitted here for brevity.

At block 312, the first network node may coordinate with the second network node to decide at least one of:
the first network node is responsible for selecting the at least one path for the UE to access the second network node,
the second network node is responsible for selecting the at least one path for the UE to access the second network node, or
the first network node is responsible for selecting at least one indirect path and the second network node is responsible for selecting a direct path and/or the at least one indirect path.

For example, the first network node may coordinate with other network node(s) which options to apply for path switching, i.e., whether the source network node serving the remote UE selects at least one candidate relay UE and the network node serving the at least one candidate relay UE(s) selects the target relay UE from the at least one candidate relay UE, or the source network node selects the target network node and the target relay UE based on assistance info from other network node(s).

FIG. 4a shows a flowchart of a method according to another embodiment of the present disclosure, which may be performed by an apparatus implemented in or at or as a second network node or communicatively coupled to the second network node. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the second network node may receive a first message comprising first information of at least one candidate relay UE served by the second network node from a first network node.

For example, the first network node the first message to the second network node at block 304 of FIG. 3a and then the second network node may receive the first message from the first network node.

In an embodiment, a handover/path switch procedure used to hand over the UE from the first network node to the second network node is to be performed.

In an embodiment, the first information may comprise at least one of respective identifier of the at least one candidate relay UE, or respective sidelink performance of the at least one candidate relay UE.

In an embodiment, the first information may comprise at least one of respective identifier of the at least one candidate relay UE, respective sidelink performance of the at least one candidate relay UE, an indication that a direct path and at least one indirect path are suitable for the UE to access the second network node, Uu performance of a direct path between the UE and the second network node, a preference of direct path or indirect path, information regarding whether the UE supports multipath to use multipath communication involving relay UE.

At block 404, the second network node may select at least one path for a UE served by the first network node to access the second network node based on the first information and assistance information regarding the at least one candidate relay UE.

In an embodiment, the at least one path may comprise at least one of at least one indirect path between the UE and the second network node, or a direct path between the UE and the second network node.

The respective identifier of the at least one candidate relay UE may be used by the second network to identify which UE is the candidate relay UE.

The assistance information regarding the at least one candidate relay UE may comprise any suitable information which can be used to select at least one path for a UE served by the first network node to access the second network node.

The assistance information may be determined by the second network and/or obtained from another network node and/or the one or more candidate relay UEs.

In an embodiment, the assistance information regarding the at least one candidate relay UE may comprise at least one of respective Uu performance of the at least one candidate relay UE, respective quality of service (QOS) supported by the at least one candidate relay UE, a best QoS supported by the at least one candidate relay UE, respective Uu discontinuous reception (DRX) configuration of the at least one candidate relay UE, respective sidelink performance of the at least one candidate relay UE, respective radio resource control (RRC) connected state of the at least one candidate relay UE, or information regarding whether the network node supports multipath communication involving relay UE.

The respective Uu performance of the at least one candidate relay UE may be measured by the second network node. Alternatively, the at least one candidate relay UE may measure its Uu performance and send it to the second network node.

The respective quality of service (QOS) supported by the at least one candidate relay UE may be determined by the second network node. Alternatively, the second network node may receive the respective quality of service (QOS) supported by the at least one candidate relay UE from the at least one candidate relay UE.

The best QoS supported by the at least one candidate relay UE may be determined by the second network node. Alternatively, the second network node may receive the best QoS supported by the at least one candidate relay UE from the at least one candidate relay UE.

The respective sidelink performance of the at least one candidate relay UE (to the UE) may be measured by the at least one candidate relay UE and reported to the second network node.

The respective Uu discontinuous reception (DRX) configuration of the at least one candidate relay UE may be configured by the second network node. Alternatively, the second network node may receive the respective Uu discontinuous reception (DRX) configuration of the at least one candidate relay UE from the at least one candidate relay UE.

The respective radio resource control (RRC) connected state of the at least one candidate relay UE may be determined by the second network node. For example, the network node can know whether a candidate relay UE is in RRC connected by checking whether the candidate relay UE has a RRC connection to the network node.

The network node can know the information regarding whether the network node supports multipath communication involving relay UE.

In an embodiment, the second network node may select at least one indirect path involving relay UE with best sidelink performance. The sidelink performance may be measured by the UE or the candidate relay UE. The UE may report the sidelink performance to the first network node which may send it to the second network node. Alternatively, the candidate relay UE may send the sidelink performance to the second network node.

In an embodiment, the second network node may select at least one indirect path and/or a direction path (if feasible) according to the indication that a direct path and at least one indirect path are suitable for the UE to access the second network node.

In an embodiment, the second network node may select a direction path (if feasible) according to Uu performance of the direct path between the UE and the second network node. The Uu performance of the direct path between the UE and the second network node may be measured by the UE and sent to the first network node. The first network node may send it to the second network node.

In an embodiment, the second network node may select at least one path according to the preference of direct path or indirect path. For example, when receiving the preference of direct path, the second network node may select the direct path if feasible. When receiving the preference of indirect path, the second network node may select at least one direct path if feasible. If the feasible path cannot be selected, the second network node may select other path.

In an embodiment, the second network node may select at least one path according to information regarding whether the UE supports multipath communication involving relay UE. For example, when the UE supports multipath communication involving relay UE, the second network may select a direct path and/or at least one indirect path if feasible. When the UE does not support multipath communication involving relay UE, the second network may select a direct path or an indirect path if feasible.

In an embodiment, the second network node may select at least one path according to information regarding whether the UE demands to use multipath communication involving relay UE. For example, when the UE demands to use multipath communication involving relay UE, the second network may select a direct path and/or at least one indirect path if feasible. When the UE does not demand to use multipath communication involving relay UE, the second network may select a direct path or an indirect path if feasible.

In an embodiment, the second network node may select at least one indirect path involving relay UE with best Uu performance.

In an embodiment, the second network node may select at least one indirect path involving relay UE with best supported QoS.

In an embodiment, the second network node may select at least one indirect path involving relay UE according to respective QoS supported by the at least one candidate relay UE.

In an embodiment, the second network node may select at least one indirect path involving relay UE according to respective Uu discontinuous reception (DRX) configuration of the at least one candidate relay UE. For example, the second network node may select at least one indirect path involving relay UE which is in wake up state.

In an embodiment, the second network node may select at least one indirect path involving relay UE which is in RRC connected state.

In an embodiment, the second network node may select at least one path according to information regarding whether the network node supports multipath communication involving relay UE. For example, when the second network node supports multipath communication involving relay UE, the second network may select a direct path and/or at least one indirect path if feasible. When the second network node does not support multipath communication involving relay UE, the second network may select a direct path or an indirect path if feasible.

In an embodiment, when the first information may comprise a preference of direct path or indirect path, the second network node may check whether a preferred path can be selected. When the preferred path can be selected, the second network node may select the preferred path. The second network node may stop checking other path.

At block 406, the second network node may send a second message to the first network node. The second message may comprise the at least one path for the UE to access the second network node.

In an embodiment, the at least one candidate relay UE is able to be used for establishing at least one indirect path between the UE and the second network node.

FIG. 4b shows a flowchart of a method according to another embodiment of the present disclosure, which may be performed by an apparatus implemented in or at or as a second network node or communicatively coupled to the second network node. As such, the apparatus may provide means or modules for accomplishing various parts of the method 410 as well as means or modules for accomplishing other processes in conjunction with other components. For some parts which have been described in the above embodiments, the description thereof is omitted here for brevity.

At block 412, the second network node may coordinate with the first network node to decide at least one of:
the first network node is responsible for selecting the at least one path for the UE to access the second network node,
the second network node is responsible for selecting the at least one path for the UE to access the second network node, or
the first network node is responsible for selecting at least one indirect path and the second network node is responsible for selecting a direct path and/or the at least one indirect path.

For example, the second network node may coordinate with other network node(s) which options to apply for path switching, i.e., whether the source network node serving the remote UE selects at least one candidate relay UE and the network node serving the at least one candidate relay UE(s) selects at least one target relay UE from the at least one candidate relay UE, or the source network node selects the target network node and the target relay UE based on assistance info from other network node(s).

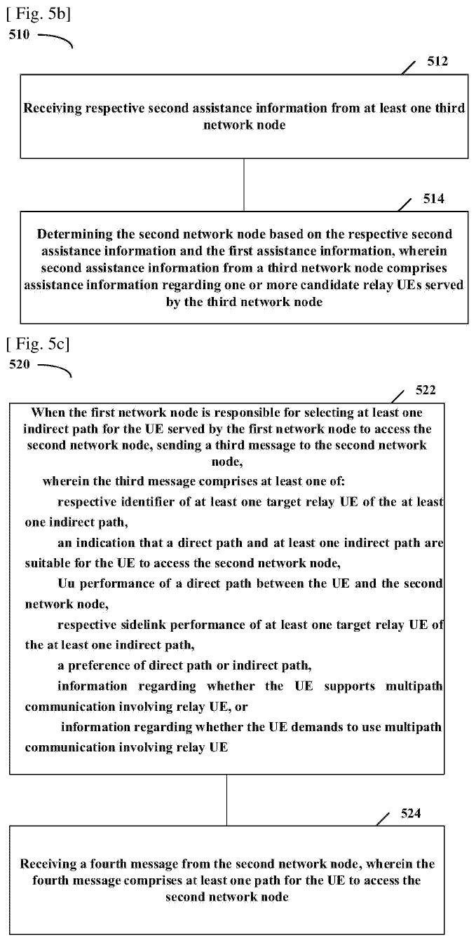

FIG. 5a shows a flowchart of a method according to another embodiment of the present disclosure, which may be performed by an apparatus implemented in or at or as a first network node or communicatively coupled to the first network node. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, the first network node may receive first assistance information regarding one or more candidate relay UEs served by a second network node from the second network node.

The first assistance information may be any suitable information which can be used by the first network node to select at least one path for a UE served by the first network node to access the second network node.

The first assistance information may be determined by the second network and/or obtained from another network node and/or the one or more candidate relay UEs.

In an embodiment, assistance information regarding one or more candidate relay UEs served by a network node may comprise at least one of respective identifier of one or more candidate relay UEs served by the network node, respective Uu performance of one or more candidate relay UEs served by the network node, respective quality of service (QOS) supported by one or more candidate relay UEs served by the network node, a best QoS supported by one or more candidate relay UEs served by the network node, respective Uu discontinuous reception (DRX) configuration of one or more candidate relay UEs served by the network node, respective sidelink performance of one or more candidate relay UEs served by the network node, or information regarding whether the network node supports multipath communication involving relay UE.

At block 504, the first network node may determine at least one candidate relay UE served by the second network node. Block 504 may be same or similar as/to block 302 of FIG. 3a.

At block 506, the first network node may select at least one path for a UE served by the first network node to access the second network node based on at least one of the first assistance information, first information of the at least one candidate relay UE, or respective radio resource control (RRC) connected state of the at least one candidate relay UE. Block 506 may be same or similar as/to block 404 of FIG. 4a.

In an embodiment, the at least one candidate relay UE is able to be used for establishing at least one indirect path between the UE and the second network node.

In an embodiment, a handover/path switch procedure used to hand over the UE from the first network node to the second network node is to be performed.

In an embodiment, assistance information regarding one or more candidate relay UEs served by a network node is received by the first network node proactively and/or in response to a request sent to the network node.

In an embodiment, the respective RRC connected state of at least one candidate relay UE served by the second network node is comprised in the first assistance information or inferred by the first network node based on the first assistance information.

In an embodiment, the at least one path may comprise at least one of at least one indirect path between the UE and the second network node, or a direct path between the UE and the second network node.

In an embodiment, the first information may comprise at least one of respective identifier of the at least one candidate relay UE, or respective sidelink performance of the at least one candidate relay UE.

In an embodiment, the first information may comprise at least one of respective identifier of the at least one candidate relay UE, respective sidelink performance of the at least one candidate relay UE, an indication that a direct path and at least one indirect path are suitable for the UE to access the second network node, Uu performance of a direct path between the UE and the second network node, a preference of direct path or indirect path, information regarding whether the UE supports multipath to use multipath communication involving relay UE.

For example, a network node such as gNB may send assistance info regarding its served relay UE(s) to other network node using e.g., inter-network node (Xn) signaling. The signaling may include one or more of the following info:
At least one served relay UE(s) which can be selected as candidate target relay UE,
The Uu performance (e.g., Uu RSRP, Uu traffic load, etc.) of the served relay UE(s),
The (best) QoS that can be supported by the served relay UE(s),
The Uu DRX configuration of the served relay UE(s),
The sidelink (e.g., PC5) performance of the served target relay UE(s) obtained from e.g., the served target relay UE(s) (e.g., PC5 traffic load),
Support of multipath communication involving relay UE.

The assistance info may be sent proactively and/or based on request from other network node.

Accordingly, a network node serving a remote UE (either via a direct path or an indirect path or both) determines the target network node and at least one target relay UE in case indirect path is selected based on the assistance info received from other network node(s), and informs this to the target network node in e.g., path switching request. In case indirect path is selected, the target network node may skip the admission control, i.e., directly accept the informed target relay UE. Besides, the network node serving the remote UE may select target relay UE taking the RRC state of the candidate target relay UE(s) into account, e.g., prioritizing candidate target relay UE(s) in RRC connected state. It can infer that a relay UE served by a different network node is not in RRC connected state if the assistance info provided by the network node does not include info about the relay UE.

FIG. 5b shows a flowchart of a method according to another embodiment of the present disclosure, which may be performed by an apparatus implemented in or at or as a first network node or communicatively coupled to the first network node. As such, the apparatus may provide means or modules for accomplishing various parts of the method 510 as well as means or modules for accomplishing other processes in conjunction with other components. For some parts which have been described in the above embodiments, the description thereof is omitted here for brevity.

At block 512, the first network node may receive respective second assistance information from at least one third network node.

At block 514, the first network node may determine the second network node based on the respective second assistance information and the first assistance information.

In an embodiment, second assistance information from a third network node may comprise assistance information regarding one or more candidate relay UEs served by the third network node as described above.

The first network node may determine the second network node based on the respective second assistance information and the first assistance information in various ways.

For example, the first network node may determine the second network node supporting multipath communication involving relay UE when the UE demands to use multipath communication involving relay UE and/or supports multipath communication involving relay UE and/or prefers indirect path and/or a direct path and at least one indirect path are suitable for the UE to access the second network node.

For example, the first network node may determine the second network node with the largest number of candidate relay UEs and/or the best sidelink performance of candidate relay UE and/or the best Uu performance of a direct path between the UE and the second network node

FIG. 5c shows a flowchart of a method according to another embodiment of the present disclosure, which may be performed by an apparatus implemented in or at or as a first network node or communicatively coupled to the first network node. As such, the apparatus may provide means or modules for accomplishing various parts of the method 520 as well as means or modules for accomplishing other processes in conjunction with other components. For some parts which have been described in the above embodiments, the description thereof is omitted here for brevity.

In this embodiment, the first network node is responsible for selecting at least one indirect path for the UE served by the first network node to access the second network node.

At block 522, the first network node may send a third message to the second network node.

The third message may comprise the selected at least one indirect path and other information which can be used by the second network to select a direct path and/or the at least one indirect path.

In an embodiment, the third message may comprise at least one of respective identifier of at least one target relay UE of the at least one indirect path, an indication that a direct path and at least one indirect path are suitable for the UE to access the second network node, Uu performance of a direct path between the UE and the second network node, respective sidelink performance of at least one target relay UE of the at least one indirect path, a preference of direct path or indirect path, information regarding whether the UE supports multipath communication involving relay UE, or information regarding whether the UE demands to use multipath communication involving relay UE.

At block 524, the first network node may receive a fourth message from the second network node.

In an embodiment, the fourth message may comprise at least one path for the UE to access the second network node.

For example, when both direct path and at least one indirect path are suitable to be used for a remote UE to access the target network node, the source network node serving the remote UE determines at least one target relay UE based on the assistance info from the target network node and sends a signaling (e.g., path switching request) to the target network node. The signaling may include one or more of the following info:
Both direct path and indirect path are suitable for the remote UE to access the target network node,
The selected target relay UE of the indirect path,
The Uu performance of the direct path, e.g., the measured Uu RSRP between the target network node and the remote UE obtained from the remote UE's measurement report,
The PC5 performance of the target relay UE, e.g., the measured PC5 RSRP to the remote UE obtained from the remote UE's measurement report.
Preference of different kinds of path, e.g., whether direct path or indirect path is preferred,

The target network node then determines whether to select the direct path and/or the indirect path based on the above info. In case the source network node provides the preference of different kinds of path, the target network node may first check whether the preferred path can be selected. if the preferred path can be selected, the target network node may select the preferred path and stop checking the other path. In case a path is selected, the target network node informs the selected path to the source network node in e.g., path switching request Ack.

In case the remote UE supports/wants to apply multipath communication involving relay UE, the network node serving the remote UE may determine the target network node and target relay UE(s) taking into account whether the candidate target network node(s) supports multipath communication involving relay UE which can be known from the assistance info from the candidate target network node(s). For candidate target network node(s) supporting multipath communication involving relay UE, the network node determines the paths (which includes at least one indirect path) that can be used for the multipath communication. In case the network node selects a network node supporting the multipath communication and selects multiple paths used for the multipath communication, the network node informs all the selected paths to the selected target network node, the selected target network node performs admission control at least for the direct path (if selected) and may reject the direct path in which case the remote UE can only access the selected target network node via the selected indirect path(s).

FIG. 5d shows a flowchart of a method according to another embodiment of the present disclosure, which may be performed by an apparatus implemented in or at or as a first network node or communicatively coupled to the first network node. As such, the apparatus may provide means or modules for accomplishing various parts of the method 530 as well as means or modules for accomplishing other processes in conjunction with other components. For some parts which have been described in the above embodiments, the description thereof is omitted here for brevity.

At block 532, the first network node may coordinate with the second network node to decide at least one of:
the first network node is responsible for selecting the at least one path for the UE to access the second network node,
the second network node is responsible for selecting the at least one path for the UE to access the second network node, or
the first network node is responsible for selecting at least one indirect path and the second network node is responsible for selecting a direct path and/or the at least one indirect path.

FIG. 5c shows a flowchart of a method according to another embodiment of the present disclosure, which may be performed by an apparatus implemented in or at or as a first network node or communicatively coupled to the first network node. As such, the apparatus may provide means or modules for accomplishing various parts of the method 540 as well as means or modules for accomplishing other processes in conjunction with other components. For some parts which have been described in the above embodiments, the description thereof is omitted here for brevity.

At block 542, the first network node may send the at least one path to the second network node.

For example, when the first network node determines the at least one path, it may inform the second network node the at least one path. The second network node may determine whether the at least one path can be configured for the UE. In addition, the second network node may perform admission control for the at least one path. For example, in case indirect path is selected, the second network node may skip the admission control, i.e., directly accept the informed target relay UE. The second network node may perform admission control at least for the direct path (if selected) and may reject the direct path in which case the remote UE can only access the selected target network node via the selected indirect path(s). The second network node may inform the at least one path accepted by the second network node to the first network.

At block 544, the first network node may send the at least one path to the UE to enable the UE to setup the at least one path. For example, the first network node may send the at least one path accepted or selected by the second network node to the UE to enable the UE to setup the at least one path. In another embodiment, the first network node may send the at least one path selected by the first network node to the UE to enable the UE to setup the at least one path.

For example, blocks 542 and 544 can be performed together. Alternatively, the first network node may only perform block 544 or 542.

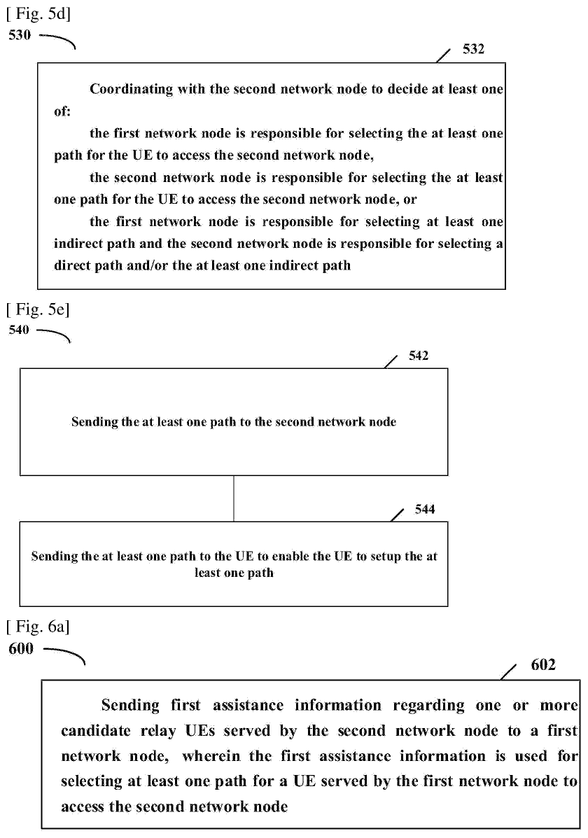

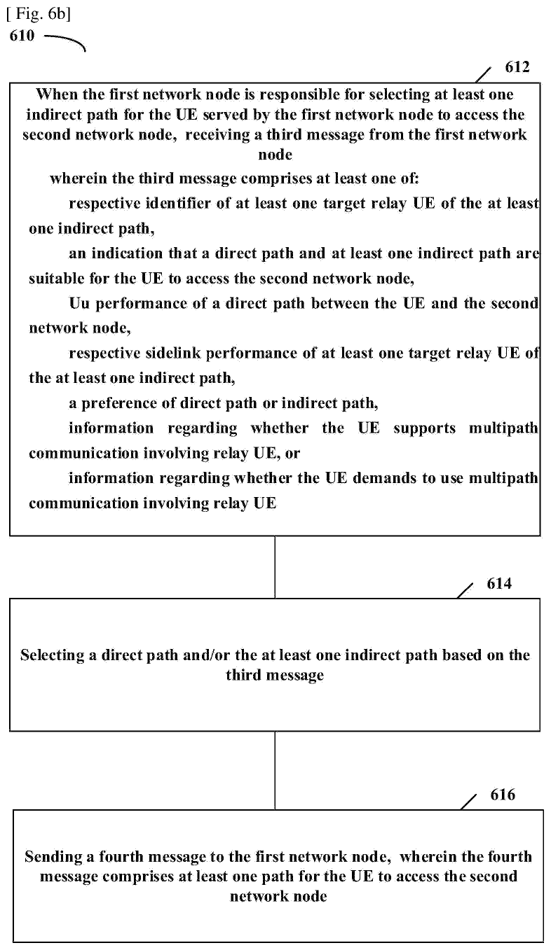

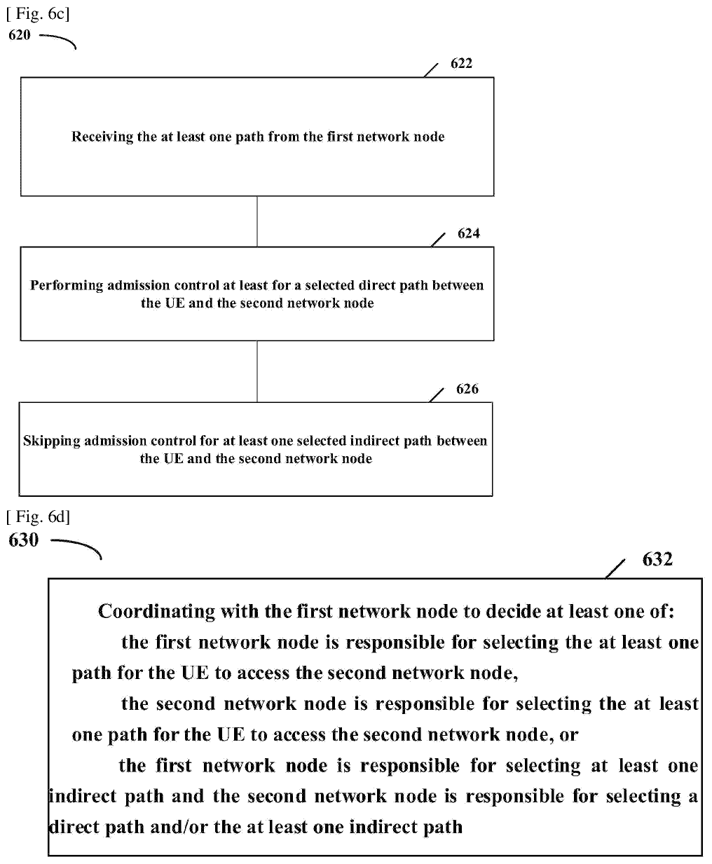

FIG. 6a shows a flowchart of a method according to another embodiment of the present disclosure, which may be performed by an apparatus implemented in or at or as a second network node or communicatively coupled to the second network node. As such, the apparatus may provide means or modules for accomplishing various parts of the method 600 as well as means or modules for accomplishing other processes in conjunction with other components. For some parts which have been described in the above embodiments, the description thereof is omitted here for brevity.

At block 602, the second network node may send first assistance information regarding one or more candidate relay UEs served by the second network node to a first network node.

In an embodiment, the first assistance information is used for selecting at least one path for a UE served by the first network node to access the second network node.

In an embodiment, handover/path switch procedure used to hand over the UE from the first network node to the second network node is to be performed.

In an embodiment, the first assistance information may comprise at least one of respective identifier of one or more candidate relay UEs served by the second network node, respective Uu performance of one or more candidate relay UEs served by the second network node, respective quality of service (QOS) supported by one or more candidate relay UEs served by the second network node, a best QoS supported by one or more candidate relay UEs served by the second network node, respective Uu discontinuous reception (DRX) configuration of one or more candidate relay UEs served by the second network node, respective sidelink performance of one or more candidate relay UEs served by the second network node, or information regarding whether the second network node supports multipath communication involving relay UE.

In an embodiment, the first assistance information is sent to the first network node proactively and/or in response to a request from the first network node.

In an embodiment, respective RRC connected state of at least one candidate relay UE served by the second network node is comprised in the first assistance information or inferred by the first network node based on the first assistance information.

FIG. 6b shows a flowchart of a method according to another embodiment of the present disclosure, which may be performed by an apparatus implemented in or at or as a second network node or communicatively coupled to the second network node. As such, the apparatus may provide means or modules for accomplishing various parts of the method 610 as well as means or modules for accomplishing other processes in conjunction with other components. For some parts which have been described in the above embodiments, the description thereof is omitted here for brevity.

In this embodiment, the first network node is responsible for selecting at least one indirect path for the UE served by the first network node to access the second network node.

At block 612, the second network node may receive a third message from the first network node.

In an embodiment, the third message may comprise at least one of respective identifier of at least one target relay UE of the at least one indirect path, an indication that a direct path and at least one indirect path are suitable for the UE to access the second network node, Uu performance of a direct path between the UE and the second network node, respective sidelink performance of at least one target relay UE of the at least one indirect path, a preference of direct path or indirect path, information regarding whether the UE supports multipath communication involving relay UE, or information regarding whether the UE demands to use multipath communication involving relay UE.

At block 614, the second network node may select a direct path and/or the at least one indirect path based on the third message. Block 614 may be same or similar as/to block 404 of FIG. 4a.

In an embodiment, when the third message comprises a preference of direct path or indirect path, the second network node may check whether a preferred path can be selected. When the preferred path can be selected, the second network node may select the preferred path. The second network node may stop checking other path.

At block 616, the second network node may send a fourth message to the first network node. The fourth message may comprise at least one path for the UE to access the second network node.

In an embodiment, the at least one path may comprise at least one of at least one indirect path between the UE and the second network node, or a direct path between the UE and the second network node.

FIG. 6c shows a flowchart of a method according to another embodiment of the present disclosure, which may be performed by an apparatus implemented in or at or as a second network node or communicatively coupled to the second network node. As such, the apparatus may provide means or modules for accomplishing various parts of the method 620 as well as means or modules for accomplishing other processes in conjunction with other components. For some parts which have been described in the above embodiments, the description thereof is omitted here for brevity.

At block 622, the second network node may receive the at least one path from the first network node. For example, when the first network node is responsible for selecting at least one path for the UE served by the first network node to access the second network node, it may send the at least one path to the second network node. After receiving the at least one path, the second network node may select one or more path from the at least one path. Alternatively, the second network node may select other path such as direct path or other indirect path.

At block 624, the second network node may perform admission control at least for a selected direct path between the UE and the second network node.

At block 626, the second network node may skip admission control for at least one selected indirect path between the UE and the second network node.

FIG. 6d shows a flowchart of a method according to another embodiment of the present disclosure, which may be performed by an apparatus implemented in or at or as a second network node or communicatively coupled to the second network node. As such, the apparatus may provide means or modules for accomplishing various parts of the method 630 as well as means or modules for accomplishing other processes in conjunction with other components. For some parts which have been described in the above embodiments, the description thereof is omitted here for brevity.

At block 632, the second network node may coordinate with the first network node to decide at least one of:
the first network node is responsible for selecting the at least one path for the UE to access the second network node,
the second network node is responsible for selecting the at least one path for the UE to access the second network node, or
the first network node is responsible for selecting at least one indirect path and the second network node is responsible for selecting a direct path and/or the at least one indirect path.

In an embodiment, the network node serving the remote UE selects at least one candidate target relay UE and the network node serving the candidate target relay UEs selects a target relay UE from the at least one candidate target relay UE.

In an embodiment, the network node serving the remote UE selects a set of candidate target relay UEs and the network node serving the candidate target relay UEs determines whether to select direct path or indirect path and the target relay UE from the set in case indirect path is selected.

In an embodiment, a network node sends assistance info regarding its served relay UE(s) to other network node(s), based on which the network node serving the remote UE selects at least one target relay UE.

In an embodiment, the target network node selects between direct path and indirect path selected by the source network node.

In an embodiment, it may configure multipath communication applied in the target network node after path switching. The indirect path is selected from the (set of) indirect path(s) determined by the source network node.

Embodiments herein may provide many advantages, of which a non-exhaustive list of examples follows. In some embodiments herein, the performance of inter-network node path switching can be improved due to that selection of indirect path is more accurate. In some embodiments herein, the benefits can be achieved in both single path scenario and multipath scenario. The embodiments herein are not limited to the features and advantages mentioned above. A person skilled in the art will recognize additional features and advantages upon reading the following detailed description.

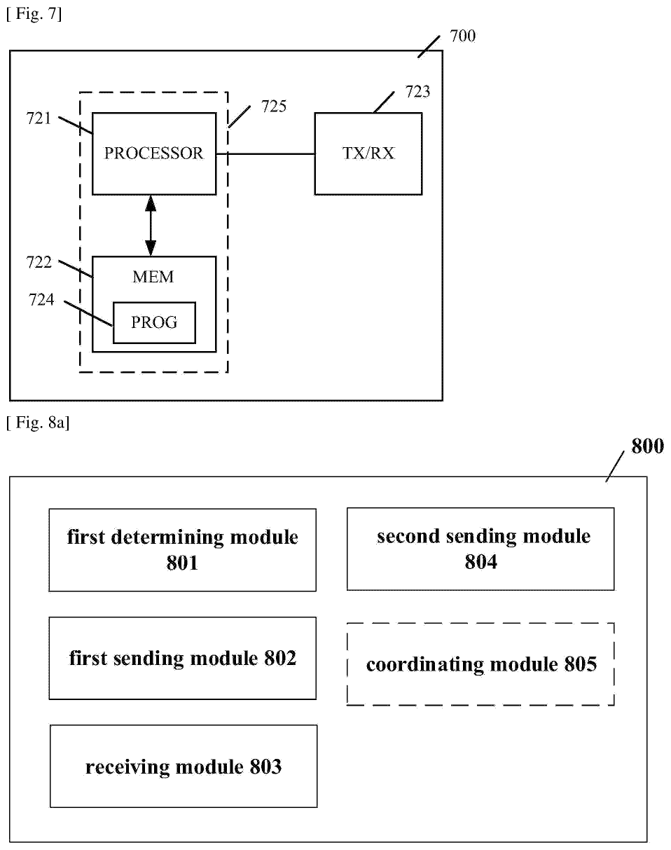

FIG. 7 is a block diagram showing an apparatus suitable for practicing some embodiments of the disclosure. For example, any one of the first network node or the second network node described above may be implemented as or through the apparatus 700

The apparatus 700 comprises at least one processor 721, such as a digital processor (DP), and at least one memory (MEM) 722 coupled to the processor 721. The apparatus 700 may further comprise a transmitter TX and receiver RX 723 coupled to the processor 721. The MEM 722 stores a program (PROG) 724. The PROG 724 may include instructions that, when executed on the associated processor 721, enable the apparatus 700 to operate in accordance with the embodiments of the present disclosure. A combination of the at least one processor 721 and the at least one MEM 722 may form processing means 725 adapted to implement various embodiments of the present disclosure.

Various embodiments of the present disclosure may be implemented by computer program executable by one or more of the processor 721, software, firmware, hardware or in a combination thereof.

The MEM 722 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 721 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first network node, the memory 722 contains instructions executable by the processor 721, whereby the first network node operates according to any of the methods related to the first network node as described above.

In an embodiment where the apparatus is implemented as or at the second network node, the memory 722 contains instructions executable by the processor 721, whereby the second network node operates according to any of the methods related to the second network node as described above.

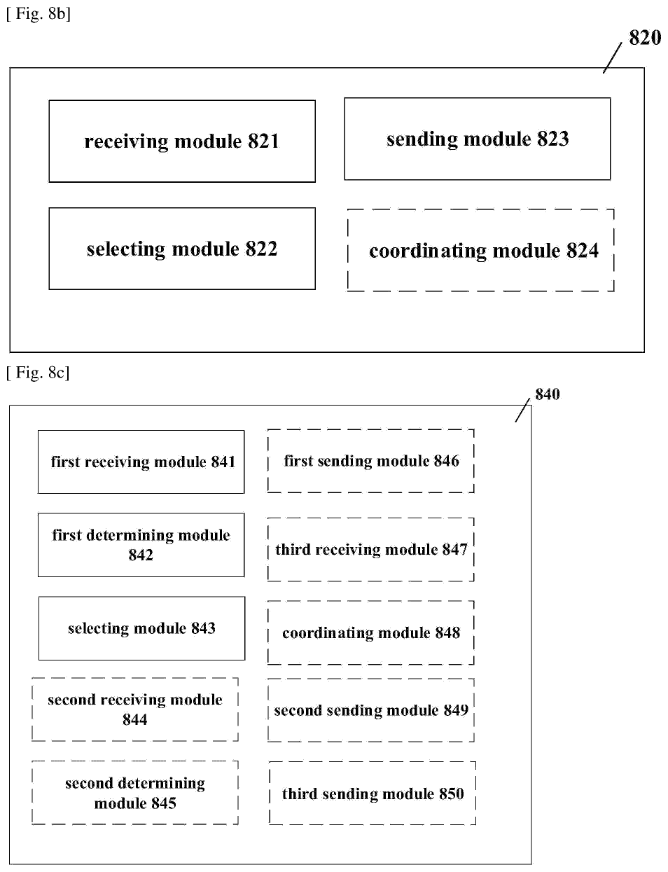

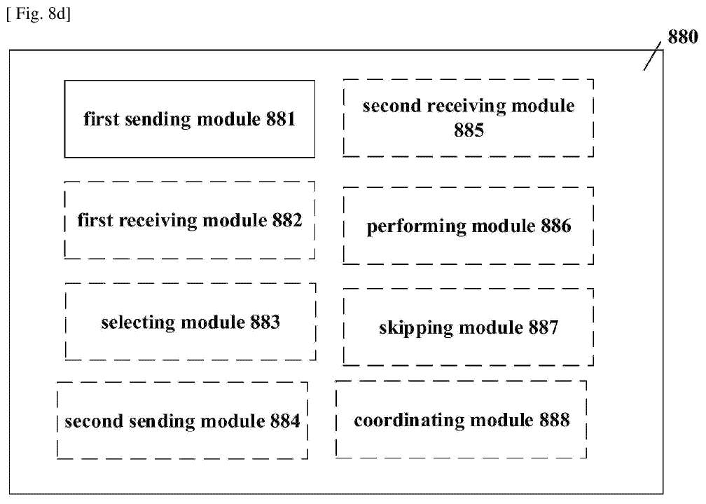

FIG. 8a is a block diagram showing a first network node according to an embodiment of the disclosure. As shown, the first network node 800 comprises a first determining module 801 configured to determine at least one candidate relay user equipment (UE) served by a second network node. The first network node 800 further comprises a first sending module 802 configured to send a first message comprising first information of the at least one candidate relay UE to the second network node. The first network node 800 further comprises a receiving module 803 configured to receive a second message from the second network node. The second message comprises at least one path for the UE to access the second network node. The first network node 800 further comprises a second sending module 804 configured to send the at least one path to a UE served by the first network node to enable the UE to setup the at least one path. The at least one candidate relay UE is able to be used for establishing at least one indirect path between the UE and the second network node.

In an embodiment, the first network node 800 may further comprise a coordinating module 805 configured to coordinate with the second network node to decide at least one of the first network node is responsible for selecting the at least one path for the UE to access the second network node, the second network node is responsible for selecting the at least one path for the UE to access the second network node, or the first network node is responsible for selecting at least one indirect path and the second network node is responsible for selecting a direct path and/or the at least one indirect path.

FIG. 8b is a block diagram showing a second network node 820 according to an embodiment of the disclosure. As shown, the second network node 820 comprises a receiving module 821 configured to receive a first message comprising first information of at least one candidate relay UE served by the second network node from a first network node. The second network node 820 further comprises a selecting module 822 configured to select at least one path for a UE served by the first network node to access the second network node based on the first information and assistance information regarding the at least one candidate relay UE. The second network node 820 further comprises a sending module 823 configured to send a second message to the first network node. The second message comprises the at least one path for the UE to access the second network node

In an embodiment, the second network node 820 may further comprise a coordinating module 824 configured to coordinate with the first network node to decide at least one of the first network node is responsible for selecting the at least one path for the UE to access the second network node, the second network node is responsible for selecting the at least one path for the UE to access the second network node, or the first network node is responsible for selecting at least one indirect path and the second network node is responsible for selecting a direct path and/or the at least one indirect path.

FIG. 8c is a block diagram showing a first network node according to another embodiment of the disclosure. As shown, the first network node 840 comprises a first receiving module 841 configured to receive first assistance information regarding one or more candidate relay UEs served by a second network node from the second network node. The first network node 840 further comprises a first determining module 842 configured to determine at least one candidate relay UE served by the second network node. The first network node 840 further comprises a selecting module 843 configured to select at least one path for a UE served by the first network node to access the second network node based on at least one of the first assistance information, first information of the at least one candidate relay UE, or respective radio resource control (RRC) connected state of the at least one candidate relay UE. The at least one candidate relay UE is able to be used for establishing at least one indirect path between the UE and the second network node.

In an embodiment, the first network node 840 may further comprise a second receiving module 844 configured to receive respective second assistance information from at least one third network node. The first network node 840 may further comprise a second determining module 845 configured to determine the second network node based on the respective second assistance information and the first assistance information. Second assistance information from a third network node comprises assistance information regarding one or more candidate relay UEs served by the third network node.

In an embodiment, when the first network node is responsible for selecting at least one indirect path for the UE served by the first network node to access the second network node, the first network node 840 may further comprise a first sending module 846 configured to send a third message to the second network node. The first network node 840 may further comprise a third receiving module 847 configured to receive a fourth message from the second network node. The fourth message comprises at least one path for the UE to access the second network node. The third message may comprise at least one of respective identifier of at least one target relay UE of the at least one indirect path, an indication that a direct path and at least one indirect path are suitable for the UE to access the second network node, Uu performance of a direct path between the UE and the second network node, respective sidelink performance of at least one target relay UE of the at least one indirect path, a preference of direct path or indirect path, information regarding whether the UE supports multipath communication involving relay UE, or information regarding whether the UE demands to use multipath communication involving relay UE.

In an embodiment, the first network node 840 may further comprise a coordinating module 848 configured to coordinate with the second network node to decide at least one of the first network node is responsible for selecting the at least one path for the UE to access the second network node, the second network node is responsible for selecting the at least one path for the UE to access the second network node, or the first network node is responsible for selecting at least one indirect path and the second network node is responsible for selecting a direct path and/or the at least one indirect path.

In an embodiment, the first network node 840 may further comprise a second sending module 849 configured to send the at least one path to the UE to enable the UE to setup the at least one path.

In an embodiment, the first network node 840 may further comprise a third sending module 850 configured to send the at least one path to the second network node.

FIG. 8d is a block diagram showing a second network node 880 according to another embodiment of the disclosure. As shown, the second network node 880 may comprise a first sending module 881 configured to send first assistance information regarding one or more candidate relay UEs served by the second network node to a first network node. The first assistance information is used for selecting at least one path for a UE served by the first network node to access the second network node.

In an embodiment, when the first network node is responsible for selecting at least one indirect path for the UE served by the first network node to access the second network node, the second network node 880 may further comprise a first receiving module 882 configured to receive a third message from the first network node. The second network node 880 may further comprise a selecting module 883 configured to select a direct path and/or the at least one indirect path based on the third message. The second network node 880 may further comprise a second sending module 884 configured to a fourth message to the first network node. The fourth message may comprise at least one path for the UE to access the second network node. The third message may comprise at least one of respective identifier of at least one target relay UE of the at least one indirect path, an indication that a direct path and at least one indirect path are suitable for the UE to access the second network node, Uu performance of a direct path between the UE and the second network node, respective sidelink performance of at least one target relay UE of the at least one indirect path, a preference of direct path or indirect path, information regarding whether the UE supports multipath communication involving relay UE, or information regarding whether the UE demands to use multipath communication involving relay UE.

In an embodiment, the second network node 880 may further comprise a second receiving module 885 configured to receive the at least one path from the first network node.

In an embodiment, the second network node 880 may further comprise a performing module 886 configured to perform admission control at least for a selected direct path between the UE and the second network node.

In an embodiment, the second network node 880 may further comprise a skipping module 887 configured to skip admission control for at least one selected indirect path between the UE and the second network node.

In an embodiment, the second network node 880 may further comprise a coordinating module 888 configured to coordinate with the first network node to decide at least one of the first network node is responsible for selecting the at least one path for the UE to access the second network node, the second network node is responsible for selecting the at least one path for the UE to access the second network node, or the first network node is responsible for selecting at least one indirect path and the second network node is responsible for selecting a direct path and/or the at least one indirect path.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the second network node or the first network node may not need a fixed processor or memory, any computing resource and storage resource may be arranged from the second network node or the first network node in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

Further, the exemplary overall commutation system including the terminal device and the network node will be introduced as below.

Embodiments of the present disclosure provide a communication system including a host computer including: processing circuitry configured to provide user data; and a communication interface configured to forward the user data to a cellular network for transmission to a terminal device. The cellular network includes a base station such as the first/second network node above mentioned, and/or the terminal device such as the UE and the relay UE above mentioned.

In embodiments of the present disclosure, the system further includes the terminal device. The terminal device is configured to communicate with the base station.

In embodiments of the present disclosure, the processing circuitry of the host computer is configured to execute a host application, thereby providing the user data; and the terminal device includes processing circuitry configured to execute a client application associated with the host application.

Embodiments of the present disclosure also provide a communication system including a host computer including: a communication interface configured to receive user data originating from a transmission from a terminal device; a base station. The transmission is from the terminal device to the base station. The base station is above mentioned network node, and/or the terminal device is above mentioned.

In embodiments of the present disclosure, the processing circuitry of the host computer is configured to execute a host application. The terminal device is configured to execute a client application associated with the host application, thereby providing the user data to be received by the host computer.

FIG. 9 is a schematic showing a wireless network in accordance with some embodiments.

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 1006, network nodes 1060 (corresponding to network side node) and 1060b, and WDs (corresponding to terminal device) 1010, 1010b, and 1010c. In practice, a wireless network may further include any additional elements suitable to support communication between wireless devices or between a wireless device and another communication device, such as a landline telephone, a service provider, or any other network node or end device. Of the illustrated components, network node 1060 and wireless device (WD) 1010 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1006 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1060 and WD 1010 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 1060 includes processing circuitry 1070, device readable medium 1080, interface 1090, auxiliary equipment 1084, power source 1086, power circuitry 1087, and antenna 1062. Although network node 1060 illustrated in the example wireless network of FIG. 9 may represent a device that includes the illustrated combination of hardware components, other embodiments may comprise network nodes with different combinations of components. It is to be understood that a network node may comprise any suitable combination of hardware and/or software needed to perform the tasks, features, functions and methods disclosed herein. Moreover, while the components of network node 1060 are depicted as single boxes located within a larger box, or nested within multiple boxes, in practice, a network node may comprise multiple different physical components that make up a single illustrated component (e.g., device readable medium 1080 may comprise multiple separate hard drives as well as multiple RAM modules).

Similarly, network node 1060 may be composed of multiple physically separate components (e.g., a NodeB component and a RNC component, or a BTS component and a BSC component, etc.), which may each have their own respective components. In certain scenarios in which network node 1060 may comprise multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1060 may be configured to support multiple radio access technologies (RATs). In such embodiments, some components may be duplicated (e.g., separate device readable medium 1080 for the different RATs) and some components may be reused (e.g., the same antenna 1062 may be shared by the RATs). Network node 1060 may also include multiple sets of the various illustrated components for different wireless technologies integrated into network node 1060, such as, for example, GSM, WCDMA, LTE, NR, WiFi, or Bluetooth wireless technologies. These wireless technologies may be integrated into the same or different chip or set of chips and other components within network node 1060.

Processing circuitry 1070 is configured to perform any determining, calculating, or similar operations (e.g., certain obtaining operations) described herein as being provided by a network node. These operations performed by processing circuitry 1070 may include processing information obtained by processing circuitry 1070 by, for example, converting the obtained information into other information, comparing the obtained information or converted information to information stored in the network node, and/or performing one or more operations based on the obtained information or converted information, and as a result of said processing making a determination.

Processing circuitry 1070 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1060 components, such as device readable medium 1080, network node 1060 functionality. For example, processing circuitry 1070 may execute instructions stored in device readable medium 1080 or in memory within processing circuitry 1070. Such functionality may include providing any of the various wireless features, functions, or benefits discussed herein. In some embodiments, processing circuitry 1070 may include a system on a chip (SOC).

In some embodiments, processing circuitry 1070 may include one or more of radio frequency (RF) transceiver circuitry 1072 and baseband processing circuitry 1074. In some embodiments, radio frequency (RF) transceiver circuitry 1072 and baseband processing circuitry 1074 may be on separate chips (or sets of chips), boards, or units, such as radio units and digital units. In alternative embodiments, part or all of RF transceiver circuitry 1072 and baseband processing circuitry 1074 may be on the same chip or set of chips, boards, or units

In certain embodiments, some or all of the functionality described herein as being provided by a network node, base station, eNB or other such network node may be performed by processing circuitry 1070 executing instructions stored on device readable medium 1080 or memory within processing circuitry 1070. In alternative embodiments, some or all of the functionality may be provided by processing circuitry 1070 without executing instructions stored on a separate or discrete device readable medium, such as in a hard-wired manner. In any of those embodiments, whether executing instructions stored on a device readable storage medium or not, processing circuitry 1070 can be configured to perform the described functionality. The benefits provided by such functionality are not limited to processing circuitry 1070 alone or to other components of network node 1060, but are enjoyed by network node 1060 as a whole, and/or by end users and the wireless network generally.

Device readable medium 1080 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1070. Device readable medium 1080 may store any suitable instructions, data or information, including a computer program, software, an application including one or more of logic, rules, code, tables, etc. and/or other instructions capable of being executed by processing circuitry 1070 and, utilized by network node 1060. Device readable medium 1080 may be used to store any calculations made by processing circuitry 1070 and/or any data received via interface 1090. In some embodiments, processing circuitry 1070 and device readable medium 1080 may be considered to be integrated.

Interface 1090 is used in the wired or wireless communication of signalling and/or data between network node 1060, network 1006, and/or WDs 1010. As illustrated, interface 1090 comprises port(s)/terminal(s) 1094 to send and receive data, for example to and from network 1006 over a wired connection. Interface 1090 also includes radio front end circuitry 1092 that may be coupled to, or in certain embodiments a part of, antenna 1062. Radio front end circuitry 1092 comprises filters 1098 and amplifiers 1096. Radio front end circuitry 1092 may be connected to antenna 1062 and processing circuitry 1070. Radio front end circuitry may be configured to condition signals communicated between antenna 1062 and processing circuitry 1070. Radio front end circuitry 1092 may receive digital data that is to be sent out to other network nodes or WDs via a wireless connection. Radio front end circuitry 1092 may convert the digital data into a radio signal having the appropriate channel and bandwidth parameters using a combination of filters 1098 and/or amplifiers 1096. The radio signal may then be transmitted via antenna 1062. Similarly, when receiving data, antenna 1062 may collect radio signals which are then converted into digital data by radio front end circuitry 1092. The digital data may be passed to processing circuitry 1070. In other embodiments, the interface may comprise different components and/or different combinations of components.

In certain alternative embodiments, network node 1060 may not include separate radio front end circuitry 1092, instead, processing circuitry 1070 may comprise radio front end circuitry and may be connected to antenna 1062 without separate radio front end circuitry 1092. Similarly, in some embodiments, all or some of RF transceiver circuitry 1072 may be considered a part of interface 1090. In still other embodiments, interface 1090 may include one or more ports or terminals 1094, radio front end circuitry 1092, and RF transceiver circuitry 1072, as part of a radio unit (not shown), and interface 1090 may communicate with baseband processing circuitry 1074, which is part of a digital unit (not shown).

Antenna 1062 may include one or more antennas, or antenna arrays, configured to send and/or receive wireless signals. Antenna 1062 may be coupled to radio front end circuitry 1090 and may be any type of antenna capable of transmitting and receiving data and/or signals wirelessly. In some embodiments, antenna 1062 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1062 may be separate from network node 1060 and may be connectable to network node 1060 through an interface or port.

Antenna 1062, interface 1090, and/or processing circuitry 1070 may be configured to perform any receiving operations and/or certain obtaining operations described herein as being performed by a network node. Any information, data and/or signals may be received from a wireless device, another network node and/or any other network equipment. Similarly, antenna 1062, interface 1090, and/or processing circuitry 1070 may be configured to perform any transmitting operations described herein as being performed by a network node. Any information, data and/or signals may be transmitted to a wireless device, another network node and/or any other network equipment.

Power circuitry 1087 may comprise, or be coupled to, power management circuitry and is configured to supply the components of network node 1060 with power for performing the functionality described herein. Power circuitry 1087 may receive power from power source 1086. Power source 1086 and/or power circuitry 1087 may be configured to provide power to the various components of network node 1060 in a form suitable for the respective components (e.g., at a voltage and current level needed for each respective component). Power source 1086 may either be included in, or external to, power circuitry 1087 and/or network node 1060. For example, network node 1060 may be connectable to an external power source (e.g., an electricity outlet) via an input circuitry or interface such as an electrical cable, whereby the external power source supplies power to power circuitry 1087. As a further example, power source 1086 may comprise a source of power in the form of a battery or battery pack which is connected to, or integrated in, power circuitry 1087. The battery may provide backup power should the external power source fail. Other types of power sources, such as photovoltaic devices, may also be used.

Alternative embodiments of network node 1060 may include additional components beyond those shown in FIG. 9 that may be responsible for providing certain aspects of the network node's functionality, including any of the functionality described herein and/or any functionality necessary to support the subject matter described herein. For example, network node 1060 may include user interface equipment to allow input of information into network node 1060 and to allow output of information from network node 1060. This may allow a user to perform diagnostic, maintenance, repair, and other administrative functions for network node 1060.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1010 includes antenna 1011, interface 1014, processing circuitry 1020, device readable medium 1030, user interface equipment 1032, auxiliary equipment 1034, power source 1036 and power circuitry 1037. WD 1010 may include multiple sets of one or more of the illustrated components for different wireless technologies supported by WD 1010, such as, for example, GSM, WCDMA, LTE, NR, WiFi, WiMAX, or Bluetooth wireless technologies, just to mention a few. These wireless technologies may be integrated into the same or different chips or set of chips as other components within WD 1010.

Antenna 1011 may include one or more antennas or antenna arrays, configured to send and/or receive wireless signals, and is connected to interface 1014. In certain alternative embodiments, antenna 1011 may be separate from WD 1010 and be connectable to WD 1010 through an interface or port. Antenna 1011, interface 1014, and/or processing circuitry 1020 may be configured to perform any receiving or transmitting operations described herein as being performed by a WD. Any information, data and/or signals may be received from a network node and/or another WD. In some embodiments, radio front end circuitry and/or antenna 1011 may be considered an interface.

As illustrated, interface 1014 comprises radio front end circuitry 1012 and antenna 1011. Radio front end circuitry 1012 comprise one or more filters 1018 and amplifiers 1016. Radio front end circuitry 1014 is connected to antenna 1011 and processing circuitry 1020, and is configured to condition signals communicated between antenna 1011 and processing circuitry 1020. Radio front end circuitry 1012 may be coupled to or a part of antenna 1011. In some embodiments, WD 1010 may not include separate radio front end circuitry 1012; rather, processing circuitry 1020 may comprise radio front end circuitry and may be connected to antenna 1011. Similarly, in some embodiments, some or all of RF transceiver circuitry 1022 may be considered a part of interface 1014. Radio front end circuitry 1012 may receive digital data that is to be sent out to other network nodes or WDs via a wireless connection. Radio front end circuitry 1012 may convert the digital data into a radio signal having the appropriate channel and bandwidth parameters using a combination of filters 1018 and/or amplifiers 1016. The radio signal may then be transmitted via antenna 1011. Similarly, when receiving data, antenna 1011 may collect radio signals which are then converted into digital data by radio front end circuitry 1012. The digital data may be passed to processing circuitry 1020. In other embodiments, the interface may comprise different components and/or different combinations of components.

Processing circuitry 1020 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, cither alone or in conjunction with other WD 1010 components, such as device readable medium 1030, WD 1010 functionality. Such functionality may include providing any of the various wireless features or benefits discussed herein. For example, processing circuitry 1020 may execute instructions stored in device readable medium 1030 or in memory within processing circuitry 1020 to provide the functionality disclosed herein.

As illustrated, processing circuitry 1020 includes one or more of RF transceiver circuitry 1022, baseband processing circuitry 1024, and application processing circuitry 1026. In other embodiments, the processing circuitry may comprise different components and/or different combinations of components. In certain embodiments processing circuitry 1020 of WD 1010 may comprise a SOC. In some embodiments, RF transceiver circuitry 1022, baseband processing circuitry 1024, and application processing circuitry 1026 may be on separate chips or sets of chips. In alternative embodiments, part or all of baseband processing circuitry 1024 and application processing circuitry 1026 may be combined into one chip or set of chips, and RF transceiver circuitry 1022 may be on a separate chip or set of chips. In still alternative embodiments, part or all of RF transceiver circuitry 1022 and baseband processing circuitry 1024 may be on the same chip or set of chips, and application processing circuitry 1026 may be on a separate chip or set of chips. In yet other alternative embodiments, part or all of RF transceiver circuitry 1022, baseband processing circuitry 1024, and application processing circuitry 1026 may be combined in the same chip or set of chips. In some embodiments, RF transceiver circuitry 1022 may be a part of interface 1014. RF transceiver circuitry 1022 may condition RF signals for processing circuitry 1020.

In certain embodiments, some or all of the functionality described herein as being performed by a WD may be provided by processing circuitry 1020 executing instructions stored on device readable medium 1030, which in certain embodiments may be a computer-readable storage medium. In alternative embodiments, some or all of the functionality may be provided by processing circuitry 1020 without executing instructions stored on a separate or discrete device readable storage medium, such as in a hard-wired manner. In any of those particular embodiments, whether executing instructions stored on a device readable storage medium or not, processing circuitry 1020 can be configured to perform the described functionality. The benefits provided by such functionality are not limited to processing circuitry 1020 alone or to other components of WD 1010, but are enjoyed by WD 1010 as a whole, and/or by end users and the wireless network generally.

Processing circuitry 1020 may be configured to perform any determining, calculating, or similar operations (e.g., certain obtaining operations) described herein as being performed by a WD. These operations, as performed by processing circuitry 1020, may include processing information obtained by processing circuitry 1020 by, for example, converting the obtained information into other information, comparing the obtained information or converted information to information stored by WD 1010, and/or performing one or more operations based on the obtained information or converted information, and as a result of said processing making a determination.

Device readable medium 1030 may be operable to store a computer program, software, an application including one or more of logic, rules, code, tables, etc. and/or other instructions capable of being executed by processing circuitry 1020. Device readable medium 1030 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1020. In some embodiments, processing circuitry 1020 and device readable medium 1030 may be considered to be integrated.

User interface equipment 1032 may provide components that allow for a human user to interact with WD 1010. Such interaction may be of many forms, such as visual, audial, tactile, etc. User interface equipment 1032 may be operable to produce output to the user and to allow the user to provide input to WD 1010. The type of interaction may vary depending on the type of user interface equipment 1032 installed in WD 1010. For example, if WD 1010 is a smart phone, the interaction may be via a touch screen; if WD 1010 is a smart meter, the interaction may be through a screen that provides usage (e.g., the number of gallons used) or a speaker that provides an audible alert (e.g., if smoke is detected). User interface equipment 1032 may include input interfaces, devices and circuits, and output interfaces, devices and circuits. User interface equipment 1032 is configured to allow input of information into WD 1010, and is connected to processing circuitry 1020 to allow processing circuitry 1020 to process the input information. User interface equipment 1032 may include, for example, a microphone, a proximity or other sensor, keys/buttons, a touch display, one or more cameras, a USB port, or other input circuitry. User interface equipment 1032 is also configured to allow output of information from WD 1010, and to allow processing circuitry 1020 to output information from WD 1010. User interface equipment 1032 may include, for example, a speaker, a display, vibrating circuitry, a USB port, a headphone interface, or other output circuitry. Using one or more input and output interfaces, devices, and circuits, of user interface equipment 1032, WD 1010 may communicate with end users and/or the wireless network, and allow them to benefit from the functionality described herein.

Auxiliary equipment 1034 is operable to provide more specific functionality which may not be generally performed by WDs. This may comprise specialized sensors for doing measurements for various purposes, interfaces for additional types of communication such as wired communications etc. The inclusion and type of components of auxiliary equipment 1034 may vary depending on the embodiment and/or scenario.

Power source 1036 may, in some embodiments, be in the form of a battery or battery pack. Other types of power sources, such as an external power source (e.g., an electricity outlet), photovoltaic devices or power cells, may also be used. WD 1010 may further comprise power circuitry 1037 for delivering power from power source 1036 to the various parts of WD 1010 which need power from power source 1036 to carry out any functionality described or indicated herein. Power circuitry 1037 may in certain embodiments comprise power management circuitry. Power circuitry 1037 may additionally or alternatively be operable to receive power from an external power source; in which case WD 1010 may be connectable to the external power source (such as an electricity outlet) via input circuitry or an interface such as an electrical power cable. Power circuitry 1037 may also in certain embodiments be operable to deliver power from an external power source to power source 1036. This may be, for example, for the charging of power source 1036. Power circuitry 1037 may perform any formatting, converting, or other modification to the power from power source 1036 to make the power suitable for the respective components of WD 1010 to which power is supplied.

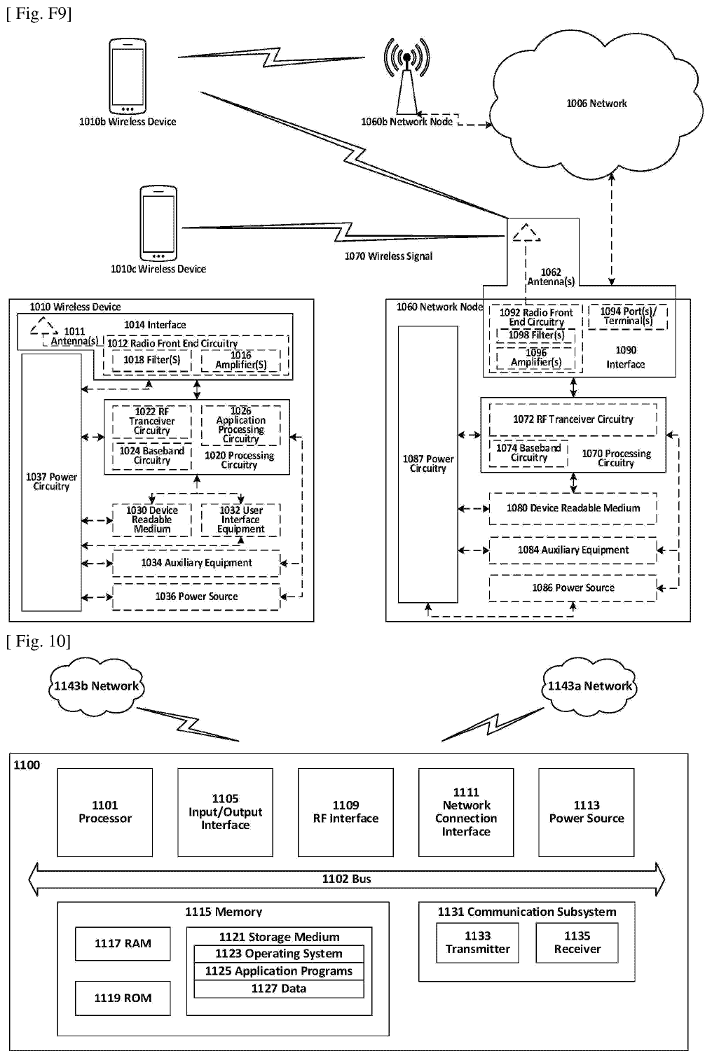

FIG. 10 is a schematic showing a user equipment in accordance with some embodiments.

FIG. 10 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1100 may be any UE identified by the 3rd Generation Partnership Project (3GPP), including a NB-IoT UE, a machine type communication (MTC) UE, and/or an enhanced MTC (eMTC) UE. UE 1100, as illustrated in FIG. 10, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 1100 includes processing circuitry 1101 that is operatively coupled to input/output interface 1105, radio frequency (RF) interface 1109, network connection interface 1111, memory 1115 including random access memory (RAM) 1117, read-only memory (ROM) 1119, and storage medium 1121 or the like, communication subsystem 1131, power source 1133, and/or any other component, or any combination thereof. Storage medium 1121 includes operating system 1123, application program 1125, and data 1127. In other embodiments, storage medium 1121 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 1101 may be configured to process computer instructions and data. Processing circuitry 1101 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1101 may include two central processing units (CPUs). Data may be information in a form suitable for use by a computer.

In the depicted embodiment, input/output interface 1105 may be configured to provide a communication interface to an input device, output device, or input and output device. UE 1100 may be configured to use an output device via input/output interface 1105. An output device may use the same type of interface port as an input device. For example, a USB port may be used to provide input to and output from UE 1100. The output device may be a speaker, a sound card, a video card, a display, a monitor, a printer, an actuator, an emitter, a smartcard, another output device, or any combination thereof. UE 1100 may be configured to use an input device via input/output interface 1105 to allow a user to capture information into UE 1100. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 1109 may be configured to provide a communication interface to RF components such as a transmitter, a receiver, and an antenna. Network connection interface 1111 may be configured to provide a communication interface to network 1143a. Network 1143a may encompass wired and/or wireless networks such as a local-area network (LAN), a wide-area network (WAN), a computer network, a wireless network, a telecommunications network, another like network or any combination thereof. For example, network 1143a may comprise a Wi-Fi network. Network connection interface 1111 may be configured to include a receiver and a transmitter interface used to communicate with one or more other devices over a communication network according to one or more communication protocols, such as Ethernet, TCP/IP, SONET, ATM, or the like. Network connection interface 1111 may implement receiver and transmitter functionality appropriate to the communication network links (e.g., optical, electrical, and the like). The transmitter and receiver functions may share circuit components, software or firmware, or alternatively may be implemented separately.

RAM 1117 may be configured to interface via bus 1102 to processing circuitry 1101 to provide storage or caching of data or computer instructions during the execution of software programs such as the operating system, application programs, and device drivers. ROM 1119 may be configured to provide computer instructions or data to processing circuitry 1101. For example, ROM 1119 may be configured to store invariant low-level system code or data for basic system functions such as basic input and output (I/O), startup, or reception of keystrokes from a keyboard that are stored in a non-volatile memory. Storage medium 1121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1121 may be configured to include operating system 1123, application program 1125 such as a web browser application, a widget or gadget engine or another application, and data file 1127. Storage medium 1121 may store, for use by UE 1100, any of a variety of various operating systems or combinations of operating systems.

Storage medium 1121 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1121 may allow UE 1100 to access computer-executable instructions, application programs or the like, stored on transitory or non-transitory memory media, to off-load data, or to upload data. An article of manufacture, such as one utilizing a communication system may be tangibly embodied in storage medium 1121, which may comprise a device readable medium.

In FIG. 10, processing circuitry 1101 may be configured to communicate with network 1143b using communication subsystem 1131. Network 1143a and network 1143b may be the same network or networks or different network or networks. Communication subsystem 1131 may be configured to include one or more transceivers used to communicate with network 1143b. For example, communication subsystem 1131 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1133 and/or receiver 1135 to implement transmitter or receiver functionality, respectively, appropriate to the RAN links (e.g., frequency allocations and the like). Further, transmitter 1133 and receiver 1135 of each transceiver may share circuit components, software or firmware, or alternatively may be implemented separately.

In the illustrated embodiment, the communication functions of communication subsystem 1131 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1131 may include cellular communication, Wi-Fi communication, Bluetooth communication, and GPS communication. Network 1143b may encompass wired and/or wireless networks such as a local-area network (LAN), a wide-area network (WAN), a computer network, a wireless network, a telecommunications network, another like network or any combination thereof. For example, network 1143b may be a cellular network, a Wi-Fi network, and/or a near-field network. Power source 1113 may be configured to provide alternating current (AC) or direct current (DC) power to components of UE 1100.

The features, benefits and/or functions described herein may be implemented in one of the components of UE 1100 or partitioned across multiple components of UE 1100. Further, the features, benefits, and/or functions described herein may be implemented in any combination of hardware, software or firmware. In one example, communication subsystem 1131 may be configured to include any of the components described herein. Further, processing circuitry 1101 may be configured to communicate with any of such components over bus 1102. In another example, any of such components may be represented by program instructions stored in memory that when executed by processing circuitry 1101 perform the corresponding functions described herein. In another example, the functionality of any of such components may be partitioned between processing circuitry 1101 and communication subsystem 1131. In another example, the non-computationally intensive functions of any of such components may be implemented in software or firmware and the computationally intensive functions may be implemented in hardware.

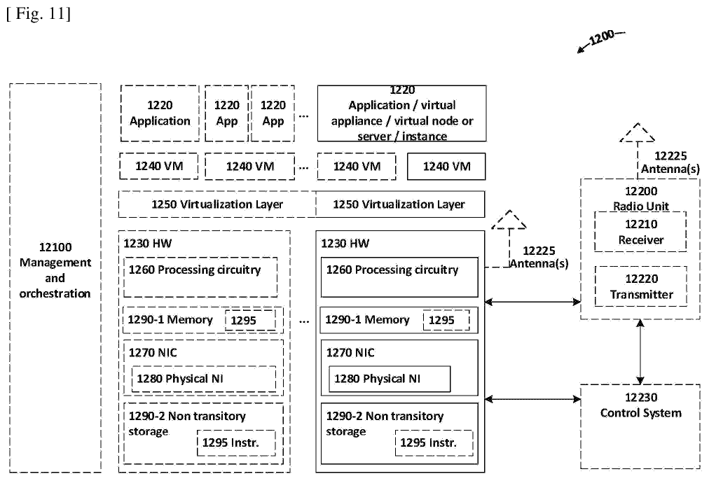

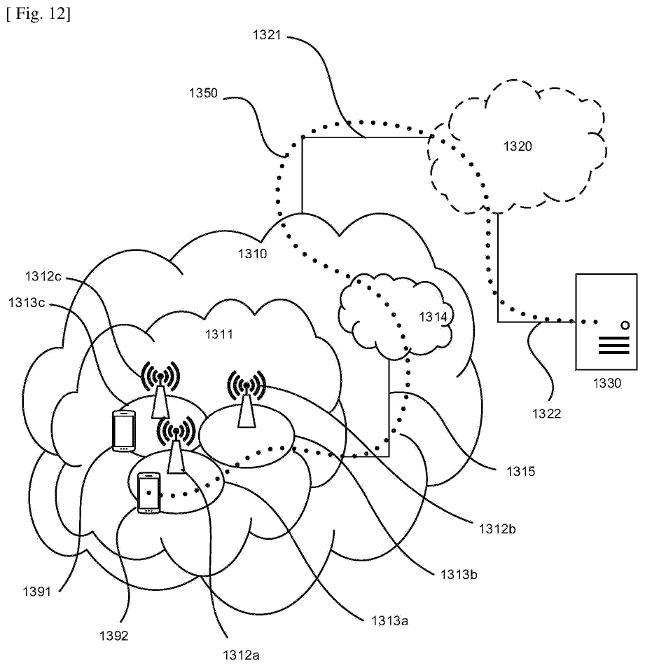

FIG. 11 is a schematic showing a virtualization environment in accordance with some embodiments.

FIG. 11 is a schematic block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1200 hosted by one or more of hardware nodes 1230. Further, in embodiments in which the virtual node is not a radio access node or does not require radio connectivity (e.g., a core network node), then the network node may be entirely virtualized.

The functions may be implemented by one or more applications 1220 (which may alternatively be called software instances, virtual appliances, network functions, virtual nodes, virtual network functions, etc.) operative to implement some of the features, functions, and/or benefits of some of the embodiments disclosed herein. Applications 1220 are run in virtualization environment 1200 which provides hardware 1230 comprising processing circuitry 1260 and memory 1290-1. Memory 1290-1 contains instructions 1295 executable by processing circuitry 1260 whereby application 1220 is operative to provide one or more of the features, benefits, and/or functions disclosed herein.

Virtualization environment 1200, comprises general-purpose or special-purpose network hardware devices 1230 comprising a set of one or more processors or processing circuitry 1260, which may be commercial off-the-shelf (COTS) processors, dedicated Application Specific Integrated Circuits (ASICs), or any other type of processing circuitry including digital or analog hardware components or special purpose processors. Each hardware device may comprise memory 1290-1 which may be non-persistent memory for temporarily storing instructions 1295 or software executed by processing circuitry 1260. Each hardware device may comprise one or more network interface controllers (NICs) 1270, also known as network interface cards, which include physical network interface 1280. Each hardware device may also include non-transitory, persistent, machine-readable storage media 1290-2 having stored therein software 1295 and/or instructions executable by processing circuitry 1260. Software 1295 may include any type of software including software for instantiating one or more virtualization layers 1250 (also referred to as hypervisors), software to execute virtual machines 1240 as well as software allowing it to execute functions, features and/or benefits described in relation with some embodiments described herein.

Virtual machines 1240, comprise virtual processing, virtual memory, virtual networking or interface and virtual storage, and may be run by a corresponding virtualization layer 1250 or hypervisor. Different embodiments of the instance of virtual appliance 1220 may be implemented on one or more of virtual machines 1240, and the implementations may be made in different ways.

During operation, processing circuitry 1260 executes software 1295 to instantiate the hypervisor or virtualization layer 1250, which may sometimes be referred to as a virtual machine monitor (VMM). Virtualization layer 1250 may present a virtual operating platform that appears like networking hardware to virtual machine 1240.

As shown in FIG. 11, hardware 1230 may be a standalone network node with generic or specific components. Hardware 1230 may comprise antenna 12225 and may implement some functions via virtualization. Alternatively, hardware 1230 may be part of a larger cluster of hardware (e.g. such as in a data center or customer premise equipment (CPE)) where many hardware nodes work together and are managed via management and orchestration (MANO) 12100, which, among others, oversees lifecycle management of applications 1220.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1240 may be a software implementation of a physical machine that runs programs as if they were executing on a physical, non-virtualized machine. Each of virtual machines 1240, and that part of hardware 1230 that executes that virtual machine, be it hardware dedicated to that virtual machine and/or hardware shared by that virtual machine with others of the virtual machines 1240, forms a separate virtual network elements (VNE).

Still in the context of NFV, Virtual Network Function (VNF) is responsible for handling specific network functions that run in one or more virtual machines 1240 on top of hardware networking infrastructure 1230 and corresponds to application 1220 in FIG. 11.

In some embodiments, one or more radio units 12200 that each include one or more transmitters 12220 and one or more receivers 12210 may be coupled to one or more antennas 12225. Radio units 12200 may communicate directly with hardware nodes 1230 via one or more appropriate network interfaces and may be used in combination with the virtual components to provide a virtual node with radio capabilities, such as a radio access node or a base station.

In some embodiments, some signalling can be effected with the use of control system 12230 which may alternatively be used for communication between the hardware nodes 1230 and radio units 12200.

FIG. 12 is a schematic showing a telecommunication network connected via an intermediate network to a host computer in accordance with some embodiments.

With reference to FIG. 12, in accordance with an embodiment, a communication system includes telecommunication network 1310, such as a 3GPP-type cellular network, which comprises access network 1311, such as a radio access network, and core network 1314. Access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to core network 1314 over a wired or wireless connection 1315. A UE 1391 located in coverage area 1313c is configured to wirelessly connect to, or be paged by, the corresponding base station 1312c. A relay UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312a or 1312b or 1312c.

Telecommunication network 1310 is itself connected to host computer 1330, which may be embodied in the hardware and/or software of a standalone server, a cloud-implemented server, a distributed server or as processing resources in a server farm. Host computer 1330 may be under the ownership or control of a service provider, or may be operated by the service provider or on behalf of the service provider. Connections 1321 and 1322 between telecommunication network 1310 and host computer 1330 may extend directly from core network 1314 to host computer 1330 or may go via an optional intermediate network 1320. Intermediate network 1320 may be one of, or a combination of more than one of, a public, private or hosted network; intermediate network 1320, if any, may be a backbone network or the Internet; in particular, intermediate network 1320 may comprise two or more sub-networks (not shown).

The communication system of FIG. 12 as a whole enables connectivity between the connected UEs 1391, 1392 and host computer 1330. The connectivity may be described as an over-the-top (OTT) connection 1350. Host computer 1330 and the connected UEs 1391, 1392 are configured to communicate data and/or signalling via OTT connection 1350, using access network 1311, core network 1314, any intermediate network 1320 and possible further infrastructure (not shown) as intermediaries. OTT connection 1350 may be transparent in the sense that the participating communication devices through which OTT connection 1350 passes are unaware of routing of uplink and downlink communications. For example, base station 1312a or 1312b or 1312c may not or need not be informed about the past routing of an incoming downlink communication with data originating from host computer 1330 to be forwarded (e.g., handed over) to a connected UE 1391. Similarly, base station 1312a or 1312b or 1312c need not be aware of the future routing of an outgoing uplink communication originating from the UE 1391 towards the host computer 1330.

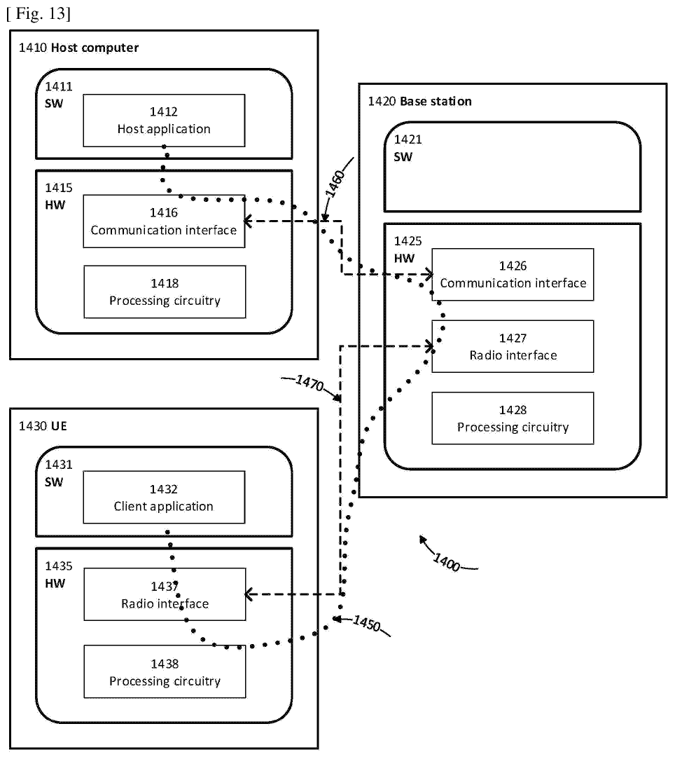

FIG. 13 is a schematic showing a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 13. In communication system 1400, host computer 1410 comprises hardware 1415 including communication interface 1416 configured to set up and maintain a wired or wireless connection with an interface of a different communication device of communication system 1400. Host computer 1410 further comprises processing circuitry 1418, which may have storage and/or processing capabilities. In particular, processing circuitry 1418 may comprise one or more programmable processors, application-specific integrated circuits, field programmable gate arrays or combinations of these (not shown) adapted to execute instructions. Host computer 1410 further comprises software 1411, which is stored in or accessible by host computer 1410 and executable by processing circuitry 1418. Software 1411 includes host application 1412. Host application 1412 may be operable to provide a service to a remote user, such as UE 1430 connecting via OTT connection 1450 terminating at UE 1430 and host computer 1410. In providing the service to the remote user, host application 1412 may provide user data which is transmitted using OTT connection 1450.

Communication system 1400 further includes base station 1420 provided in a telecommunication system and comprising hardware 1425 enabling it to communicate with host computer 1410 and with UE 1430. Hardware 1425 may include communication interface 1426 for setting up and maintaining a wired or wireless connection with an interface of a different communication device of communication system 1400, as well as radio interface 1427 for setting up and maintaining at least wireless connection 1470 with UE 1430 located in a coverage area (not shown in FIG. 13) served by base station 1420. Communication interface 1426 may be configured to facilitate connection 1460 to host computer 1410. Connection 1460 may be direct or it may pass through a core network (not shown in FIG. 13) of the telecommunication system and/or through one or more intermediate networks outside the telecommunication system. In the embodiment shown, hardware 1425 of base station 1420 further includes processing circuitry 1428, which may comprise one or more programmable processors, application-specific integrated circuits, field programmable gate arrays or combinations of these (not shown) adapted to execute instructions. Base station 1420 further has software 1421 stored internally or accessible via an external connection.

Communication system 1400 further includes UE 1430 already referred to. Its hardware 1435 may include radio interface 1437 configured to set up and maintain wireless connection 1470 with a base station serving a coverage area in which UE 1430 is currently located. Hardware 1435 of UE 1430 further includes processing circuitry 1438, which may comprise one or more programmable processors, application-specific integrated circuits, field programmable gate arrays or combinations of these (not shown) adapted to execute instructions. UE 1430 further comprises software 1431, which is stored in or accessible by UE 1430 and executable by processing circuitry 1438. Software 1431 includes client application 1432. Client application 1432 may be operable to provide a service to a human or non-human user via UE 1430, with the support of host computer 1410. In host computer 1410, an executing host application 1412 may communicate with the executing client application 1432 via OTT connection 1450 terminating at UE 1430 and host computer 1410. In providing the service to the user, client application 1432 may receive request data from host application 1412 and provide user data in response to the request data. OTT connection 1450 may transfer both the request data and the user data. Client application 1432 may interact with the user to generate the user data that it provides.

It is noted that host computer 1410, base station 1420 and UE 1430 illustrated in FIG. 13 may be similar or identical to host computer 1330, one of base stations 1312a, 1312b, 1312c and one of UEs 1391, 1392 of FIG. 12, respectively. This is to say, the inner workings of these entities may be as shown in FIG. 13 and independently, the surrounding network topology may be that of FIG. 12.

In FIG. 13, OTT connection 1450 has been drawn abstractly to illustrate the communication between host computer 1410 and UE 1430 via base station 1420, without explicit reference to any intermediary devices and the precise routing of messages via these devices. Network infrastructure may determine the routing, which it may be configured to hide from UE 1430 or from the service provider operating host computer 1410, or both. While OTT connection 1450 is active, the network infrastructure may further take decisions by which it dynamically changes the routing (e.g., on the basis of load balancing consideration or reconfiguration of the network).

Wireless connection 1470 between UE 1430 and base station 1420 is in accordance with the teachings of the embodiments described throughout this disclosure. One or more of the various embodiments improve the performance of OTT services provided to UE 1430 using OTT connection 1450, in which wireless connection 1470 forms the last segment. More precisely, the teachings of these embodiments may improve the latency, and power consumption for a reactivation of the network connection, and thereby provide benefits, such as reduced user waiting time, enhanced rate control.

A measurement procedure may be provided for the purpose of monitoring data rate, latency and other factors on which the one or more embodiments improve. There may further be an optional network functionality for reconfiguring OTT connection 1450 between host computer 1410 and UE 1430, in response to variations in the measurement results. The measurement procedure and/or the network functionality for reconfiguring OTT connection 1450 may be implemented in software 1411 and hardware 1415 of host computer 1410 or in software 1431 and hardware 1435 of UE 1430, or both. In embodiments, sensors (not shown) may be deployed in or in association with communication devices through which OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of OTT connection 1450 may include message format, retransmission settings, preferred routing etc.; the reconfiguring need not affect base station 1420, and it may be unknown or imperceptible to base station 1420. Such procedures and functionalities may be known and practiced in the art. In certain embodiments, measurements may involve proprietary UE signalling facilitating host computer 1410's measurements of throughput, propagation times, latency and the like. The measurements may be implemented in that software 1411 and 1431 causes messages to be transmitted, in particular empty or ‘dummy’ messages, using OTT connection 1450 while it monitors propagation times, errors etc.

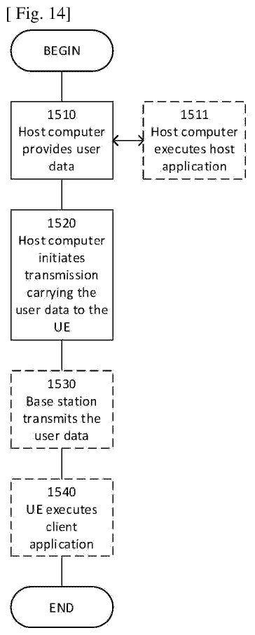

FIG. 14 is a schematic showing methods implemented in a communication system including a host computer, a base station and a user equipment in accordance with some embodiments.

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 1510, the host computer provides user data. In substep 1511 (which may be optional) of step 1510, the host computer provides the user data by executing a host application. In step 1520, the host computer initiates a transmission carrying the user data to the UE. In step 1530 (which may be optional), the base station transmits to the UE the user data which was carried in the transmission that the host computer initiated, in accordance with the teachings of the embodiments described throughout this disclosure. In step 1540 (which may also be optional), the UE executes a client application associated with the host application executed by the host computer.

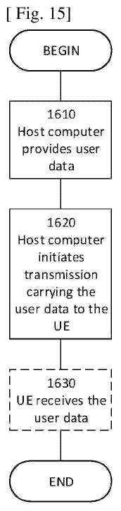

FIG. 15 is a schematic showing methods implemented in a communication system including a host computer, a base station and a user equipment in accordance with some embodiments.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 1610 of the method, the host computer provides user data. In an optional substep (not shown) the host computer provides the user data by executing a host application. In step 1620, the host computer initiates a transmission carrying the user data to the UE. The transmission may pass via the base station, in accordance with the teachings of the embodiments described throughout this disclosure. In step 1630 (which may be optional), the UE receives the user data carried in the transmission.

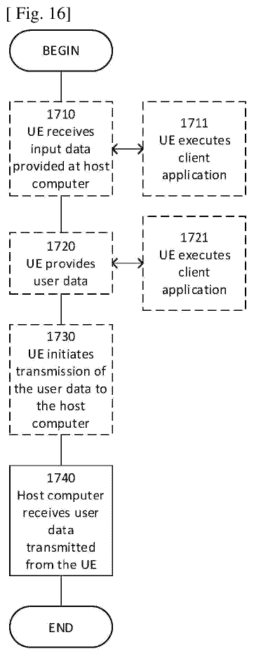

FIG. 16 is a schematic showing methods implemented in a communication system including a host computer, a base station and a user equipment in accordance with some embodiments.

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 1710 (which may be optional), the UE receives input data provided by the host computer. Additionally or alternatively, in step 1720, the UE provides user data. In substep 1721 (which may be optional) of step 1720, the UE provides the user data by executing a client application. In substep 1711 (which may be optional) of step 1710, the UE executes a client application which provides the user data in reaction to the received input data provided by the host computer. In providing the user data, the executed client application may further consider user input received from the user. Regardless of the specific manner in which the user data was provided, the UE initiates, in substep 1730 (which may be optional), transmission of the user data to the host computer. In step 1740 of the method, the host computer receives the user data transmitted from the UE, in accordance with the teachings of the embodiments described throughout this disclosure.

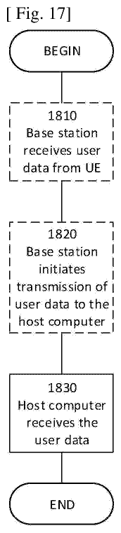

FIG. 17 is a schematic showing methods implemented in a communication system including a host computer, a base station and a user equipment in accordance with some embodiments.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 1810 (which may be optional), in accordance with the teachings of the embodiments described throughout this disclosure, the base station receives user data from the UE. In step 1820 (which may be optional), the base station initiates transmission of the received user data to the host computer. In step 1830 (which may be optional), the host computer receives the user data carried in the transmission initiated by the base station.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a first network node, the method comprising:
determining at least a first candidate relay user equipment (UE) served by a second network node;
sending a first message comprising first information of the first candidate relay UE to the second network node;
receiving a second message from the second network node, wherein the second message comprises at least one path for a UE served by the first network node to access the second network node; and
sending the at least one path to the UE served by the first network node to enable the UE to setup the at least one path,
wherein the first candidate relay UE is able to be used for establishing at least one indirect path between the UE and the second network node.

2. The method of claim 1, wherein a handover/path switch procedure used to hand over the UE from the first network node to the second network node is to be performed.

3. The method of claim 1, wherein the first information comprises:
an identifier of the first candidate relay UE, and/or
information indicating a sidelink performance the first candidate relay UE.

4. The method of claim 1, wherein the first information comprises at least one of:
respective identifier of the first candidate relay UE,
respective sidelink performance of the first candidate relay UE,
an indication that a direct path and at least one indirect path are suitable for the UE to access the second network node,
Uu performance of a direct path between the UE and the second network node,
a preference of direct path or indirect path,
information regarding whether the UE supports multipath communication involving relay UE, or
information regarding whether the UE demands to use multipath communication involving relay UE.

5. The method of claim 1, wherein the at least one path comprises at least one of:
at least one indirect path between the UE and the second network node, or
a direct path between the UE and the second network node.

6. The method of claim 1, further comprising:
coordinating with the second network node to decide at least one of:
the first network node is responsible for selecting the at least one path for the UE to access the second network node,
the second network node is responsible for selecting the at least one path for the UE to access the second network node, or
the first network node is responsible for selecting at least one indirect path and the second network node is responsible for selecting a direct path and/or the at least one indirect path.

7. A method performed by a second network node, comprising:
receiving a first message comprising first information of at least a first candidate relay UE served by the second network node from a first network node;
selecting at least one path for a UE served by the first network node to access the second network node based on the first information and assistance information regarding the first candidate relay UE;
sending a second message to the first network node, wherein the second message comprises the at least one path for the UE to access the second network node,
wherein the first candidate relay UE is able to be used for establishing at least one indirect path between the UE and the second network node.

8. The method of claim 7, wherein a handover/path switch procedure used to hand over the UE from the first network node to the second network node is to be performed.

9. The method of claim 7, wherein the first information comprises at least one of:
respective identifier of the first candidate relay UE, or
respective sidelink performance of the first candidate relay UE.

10. The method of claim 7, wherein the first information comprises at least one of:
respective identifier of the first candidate relay UE,
respective sidelink performance of the first candidate relay UE,
an indication that a direct path and at least one indirect path are suitable for the UE to access the second network node,
Uu performance of a direct path between the UE and the second network node,
a preference of direct path or indirect path,
information regarding whether the UE supports multipath communication involving relay UE, or
information regarding whether the UE demands to use multipath communication involving relay UE.

11. The method of claim 7, wherein the assistance information regarding the first candidate relay UE comprises at least one of:
respective Uu performance of the first candidate relay UE,
respective quality of service (QOS) supported by the first candidate relay UE,
a best QoS supported by the first candidate relay UE,
respective Uu discontinuous reception (DRX) configuration of the first candidate relay UE,
respective sidelink performance of the first candidate relay UE,
respective radio resource control (RRC) connected state of the first candidate relay UE, or
information regarding whether the network node supports multipath communication involving relay UE.

12. The method of claim 7, wherein selecting at least one path for a UE served by the first network node to access the second network node based on the first information comprises:
when the first information comprises a preference of direct path or indirect path, checking whether a preferred path can be selected;
when the preferred path can be selected, selecting the preferred path; and
stopping checking other path.

13. The method of claim 7, wherein the at least one path comprises at least one of:
at least one indirect path between the UE and the second network node, or
a direct path between the UE and the second network node.

14. The method of claim 7, further comprising:
coordinating with the first network node to decide at least one of:
the first network node is responsible for selecting the at least one path for the UE to access the second network node,
the second network node is responsible for selecting the at least one path for the UE to access the second network node, or
the first network node is responsible for selecting at least one indirect path and the second network node is responsible for selecting a direct path and/or the at least one indirect path.

15-37. (canceled)

38. A first network node, comprising:
a processor; and
a memory coupled to the processor, said the memory containing instructions executable by the processor, whereby the first network node is operative to:
determine at least a first candidate relay user equipment (UE) served by a second network node;
send a first message comprising first information of the first candidate relay UE to the second network node;
receive a second message from the second network node, wherein the second message comprises at least one path for a UE served by the first network node to access the second network node; and
send the at least one path to the UE served by the first network node to enable the UE to setup the at least one path,
wherein the first candidate relay UE is able to be used for establishing at least one indirect path between the UE and the second network node.

39. The first network node of claim 38, wherein the first information comprises:
an identifier of the first candidate relay UE, and/or
information indicating a sidelink performance of the first candidate relay UE.

40-47. (canceled)

48. The first network node of claim 38, wherein the first information comprises:
an identifier of the first candidate relay UE, and/or
information indicating a sidelink performance of the first candidate relay UE.

49. The first network node of claim 38, wherein the first information comprises:
an identifier of the first candidate relay UE,
information indicating sidelink performance of the first candidate relay UE,
an indication that a direct path and at least one indirect path are suitable for the UE to access the second network node,
information indicating a Uu performance of a direct path between the UE and the second network node,
information indicating a preference of direct path or indirect path,
information regarding whether the UE supports multipath communication involving relay UE, and/or
information regarding whether the UE demands to use multipath communication involving relay UE.

50. The first network node of claim 38, wherein the at least one path comprises:
at least one indirect path between the UE and the second network node, and/or
a direct path between the UE and the second network node.

51. The first network node of claim 38, wherein the first network node is further operative to coordinate with the second network node to decide:
the first network node is responsible for selecting the at least one path for the UE to access the second network node,
the second network node is responsible for selecting the at least one path for the UE to access the second network node, and/or
the first network node is responsible for selecting at least one indirect path and the second network node is responsible for selecting a direct path and/or the at least one indirect path.
